(19) United States
(12) Patent Application Publication
(10) Pub. No.: US 2012/0214335 A1
(43) Pub. Date: Aug. 23, 2012

(54) COVER FOR CABLE CONNECTORS

(75) Inventors: Christopher P. Natoli, Fulton, NY (US); Mark Vaughn, Cape Vincent, NY (US); Noah P. Montena, Syracuse, NY (US)

(73) Assignee: John Mezzalingua Associates, Inc., East Syracuse, NY (US)

(21) Appl. No.: 13/401,835

(22) Filed: Feb. 21, 2012

Related U.S. Application Data
(63) Continuation-in-part of application No. 13/237,563, filed on Sep. 20, 2011.
Application No. 13/237,563 is a division of application No. 12/945,525, filed on Nov. 12, 2010, now Pat. No. 8,062,045.
Application No. 12/945,525 is a division of application No. 12/414,255, filed on Mar. 30, 2009, now Pat. No. 7,838,775.
(60) Provisional application No. 61/548,912, filed on Oct. 19, 2011.

(51) Int. Cl. H01R 13/52

(52) U.S. Cl. 439/519

(57) ABSTRACT

A cover and a system of covers/boots for placement in sealed relation over a connector or pair of connectors that is or are adapted to terminate a cable or splice together a pair of cables, preferably cables that carry signals received by a receiving apparatus on a cell tower. The covers include a cable end that sealingly receives a cable therein, an elongated body that provides secure cover to a cable connector, and an interface cover that cooperates with the elongated body to seal the connector interface when disconnected.

### CROSS-REFERENCE TO RELATED APPLICATIONS

The present application is a Continuation-in-Part of and claims priority from U.S. patent application no. 13/237,563, filed Sep. 20, 2011, entitled, “Cover for Cable Connectors,” which is a Divisional of U.S. patent application Ser. No. 12/945,525, filed Nov. 12, 2010, entitled, “Cover for Cable Connectors,” now U.S. Pat. No. 8,062,045, issued Nov. 22, 2011, which is a Divisional of U.S. patent application Ser. No. 12/414,255, filed Mar. 30, 2009, entitled, “Cover for Cable Connectors,” now U.S. Pat. No. 7,838,775, issued Nov. 23, 2010. The present application further claims priority to the U.S. Provisional patent application 61/548,912, filed Oct. 19, 2011, entitled, “Protective Connector Cap.”

### BACKGROUND

1. Field

The subject matter disclosed herein relates generally to covers for cable connectors, and more particularly to a coaxial cable connector interface cover that cooperates with a coaxial cable connector cover to protect the coaxial cable and connector from environmental degradation.

2. Description of the Related Art

Transmission line components such as connectors are often exposed to the open environment and are thus susceptible to degradation from weather related corrosive effects (e.g., moisture infiltration), pollution, debris and other elements. Degradation of the components potentially leads to degradation of the signal quality being transmitted through the cables.

To protect the components of a transmission line installation from environmental effects, layers of tape have been used to cover and seal the components, creating what have conventionally been referred to as tape-wrap seals. The tape layers typically consist of a first layer of electrical tape, followed by a layer of butyl tape, and then followed by another layer of electrical tape. While the layering of tape does in certain instances provide for a secure seal, it is not without its drawbacks.

First, the taping requires significant time in its initial installation, and needs to be removed in order to gain access to the component when servicing the components (and then reapplied after servicing is complete). The time associated with the taping and removal thereof when servicing the components is costly. In addition, the quality of the seal is dependant on the skill of the worker that is applying the tape. As such, inconsistent application of the tape may lead to instances of ineffective sealing of components.

Second, the properties inherent in the material composition of the tape subjects the tape to size fluctuation and inconsistent adherence. If the tape contracts in colder temperatures and loses adherence strength in warmer temperatures, for example, the quality of the seal created through the tape becomes compromised in regions that experience wide temperature fluctuation. In addition, the same pollutants and other environmental factors that affect the components when unsealed may also affect the sealing quality of the tape.

In addition to taping as a sealing provision, plastic clamshell or valise type covers have been used to envelop the components. These style covers are exemplified by the plastic material composition and the closure mechanisms used to open and close them around the components. While the opening and closing of the clamshell style cover facilitates quicker installation and removal in repair situations, it too is not without its drawbacks. For instance, the plastic material becomes brittle in colder temperatures, and this reduction in ductility increases over time. As the material becomes more brittle, the closure mechanisms lose their effectiveness often breaking or otherwise not reliably performing the closure function for which they were designed. Furthermore, the clamshell style closures include seams that extend essentially the entire periphery of the cover, making the sealing function much more difficult when compared to covers that do not include such long seams between parts. As such, the clamshell style covers lose their sealing effectiveness over time and in climates that routinely experience cold temperatures.

There is also a need for protective elements such as cable covers that are designed to cover and protect transmission line components such as connectors which are angled or otherwise variable.

Furthermore, unconnected or unterminated cable connector interfaces and jumper assemblies are subject to environmental hazards, weather elements, and physical damage, such as damage from water, dirt, dust, insects, and other matter. Moisture, for example, poses a significant threat of damage. Some forms of moisture include, but are not limited to, rain, mist, condensation, high relative humidity, and flooding.

During construction of cell phone towers or other transmission line installations, a preassembled jumper may remain unterminated onsite for several days. During the construction, the unterminated jumper assembly may be exposed to the hazards of an outdoor environment. Where the cable connector is field installable, the connectorization of the cable may take place well before the connector is installed into the system, subjecting the unterminated connector to environmental hazards. When water gets inside a connector, it can cause significant damage. In particular, water can catalyze corrosion. Corroded parts can negatively affect the electrical characteristics of the cable connector, which can negatively alter signals carried along conductors connected to the connector.

Dust, dirt, and physical damage can also negatively affect the quality of the electrical signals conducted through the connector. Dirt and dust can be a nuisance, can contribute to corrosion, or can cause physical damage to electrical components through grating or friction. Physical impact, physical stress, and heavy friction can break components of the connector or otherwise damage components of the connector so the connector does not function properly in either a physical or an electrical capacity.

Damage can occur to a connector before the connector is used, or any time the connector is not used, such as during storage, transportation, installation, etc. Damaged connectors are waste. Damaged connectors can also be inadvertently or unknowingly installed in telecommunication systems, and these damaged connectors can cause significant problems in delivering telecommunication services. Signal alteration, or loss of desirable signals can cause some form of disruption in the telecommunication services provided to a user.

Protective connector caps, or interface covers, can offer a wide range of protection for a connector port not in use. Currently, protective caps fit over the interface end of the connector or inside the interface end of the connector, thereby covering the interface from the external environment and potential environmental hazards. These protective caps each fit one type and gender of interface. Therefore, for each different connector, each different interface size and gender requires differently sized and/or shaped protective covers that must be manufactured to appropriately fit and protect valuable connectors.

Each additional protective connector cap size requires additional tooling, labor, and expense to manufacture the different parts. Furthermore, the additional parts increase the amount of labor categorizing the parts for inventory, storing the parts in inventory, and retrieving the parts from inventory. With an interface cover for every connector, and a large multitude of types and sizes of connectors, the financial expense associated with manufacturing and inventorying the equally large multitude of protective connector caps is very large.

### SUMMARY

a first aspect of the present invention provides a cover for a connector adapted to terminate a cable, wherein the connector includes a body portion and a coupling element. The cover comprises: (i) a unitary elongated body member having a cable end, a bulkhead end, an interior surface, and an exterior surface, where the unitary elongated body extends along a longitudinal axis; (ii) a plurality of spaced apart grooves formed in a predetermined region of the interior surface of the body member, proximate the cable end; and (iii) wherein the interior surface of the body member is adapted to sealingly engage the connector in an area proximate the bulkhead end. The cover is composed of a rubber material, preferably a silicone rubber. The exterior surface of the cover can include at least one wing formed on the exterior surface that serves as a gripping surface for a tool or manual engagement (e.g., fingers) used to remove the cover from a connector by axial sliding of the cover. The cover can further include an adaptor that is in removable communication with the cover and is preferably composed of a plastic material. At least a portion of the adaptor is positioned between the connector and the interior surface of the cover. The cover can further include an annular ridge that is formed to forcibly fit over the connector.

A second aspect of the present invention provides a cover for a connector adapted to terminate a cable, the cover comprising: (i) a unitary elongated body member having a cable end, a connector end, an interior surface, and an exterior surface, where the unitary elongated body extends along a longitudinal axis; and (ii) wherein the exterior surface comprises a first region extending from the cable end to a first shoulder and including at least one strain relief member defined therein, the first region having a minimum, first cross-sectional diameter, a second region extending from the first shoulder to a second shoulder, the second region having a minimum, second cross-sectional diameter that is less than the minimum, first cross-sectional diameter, and a third region extending from the second shoulder to the connector end, the third region having a minimum, third cross-sectional diameter that is greater than the minimum, second cross-sectional diameter. Each of the strain members comprise a circumferential groove extending less than completely around the circumference of said first region of the exterior surface. The cover can optionally include a plurality of spaced-apart grooves in one of the interior regions, preferably the interior region proximate the cable end. Each of the grooves extend in spaced parallel relation to the others.

A third aspect of the present invention provides a cover for a connector adapted to terminate a cable, the cover comprising: (i) a unitary elongated body member having a cable end, a connector end, an interior surface, and an exterior surface, the unitary elongated body extending along a longitudinal axis; and (ii) wherein the interior surface comprises a first region adapted to cover at least a portion of the cable and extending from the cable end to a first shoulder, the first region having a minimum, first cross-sectional diameter, and a second region adapted to cover at least the connector body portion and that extends from the first shoulder to a second shoulder, the second region having a minimum, second cross-sectional diameter that is greater than the minimum, first cross-sectional diameter. The exterior surface of the cover can optionally comprise a first region extending from the cable end to a third shoulder and include at least one strain relief member defined therein, the first region having a minimum, third cross-sectional diameter, a second region extending from the third shoulder to a fourth shoulder, the second region having a minimum, fourth cross-sectional diameter that is less than the minimum, third cross-sectional diameter, and a third region extending from the fourth shoulder to the connector end, the third region having a minimum, fifth cross-sectional diameter that is greater than the minimum, fourth cross-sectional diameter.

A fourth aspect of the present invention provides a cover for a connector adapted to terminate a cable, the cover comprising: (i) a unitary elongated body member having a cable end, a connector end, an interior surface, and an exterior surface, the unitary elongated body extending along a longitudinal axis; and (ii) wherein the interior surface includes a first region extending from the cable end to a first shoulder, the first region being of a minimum, first cross-sectional diameter, a second region extending from the first shoulder to a second shoulder, the second region being of an minimum, second cross-sectional diameter that is greater than the minimum, first cross-sectional diameter, and a third region extending from the second shoulder to the connector end, the third region being of a minimum, third cross-sectional diameter that is greater than the minimum, second cross-sectional diameter. The cover can optionally further comprise: (iii) wherein the exterior surface comprises a first region extending from the cable end to a third shoulder and including at least one strain relief member defined therein, the first region having a minimum, fourth cross-sectional diameter, a second region extending from the third shoulder to a fourth shoulder, the second region having a minimum, fifth cross-sectional diameter that is less than the minimum, fourth cross-sectional diameter, and a third region extending from said fourth shoulder to the connector end, the third region having a minimum, sixth cross-sectional diameter that is greater than the minimum, fifth cross-sectional diameter.

A fifth aspect of the present invention provides a cover for a connector adapted to terminate a cable, the cover comprising: (i) a unitary elongated body member having a cable end, a connector end, an interior surface, and an exterior surface, said unitary elongated body extending along a longitudinal axis; (ii) wherein said interior surface includes a first region adapted to cover at least a portion of the signal carrying cable and extending from said cable end to a first shoulder, said first region being of a minimum, first cross-sectional diameter, a second region adapted to cover at least the connector body portion and that extends from said first shoulder to a second shoulder, said second region being of an minimum, second cross-sectional diameter that is greater than said minimum, first cross-sectional diameter, a third region adapted to cover at least the coupling element and extending from said second shoulder to a third shoulder, said third region being of a minimum, third cross-sectional diameter that is larger than said second cross-sectional diameter, and a fourth region adapted to cover the shank portion and that extends from said third shoulder to said connector end, said fourth region being of a minimum, fourth cross-sectional diameter that is greater than said minimum, third cross-sectional diameter. The cover can optionally further comprise: (iii) wherein the exterior surface comprises a first region extending from the cable end to a fourth shoulder and including at least one strain relief member defined therein, the first region having a minimum, fifth cross-sectional diameter, a second region extending from the fourth shoulder to a fifth shoulder, the second region having a minimum, sixth cross-sectional diameter that is less than the minimum, fifth cross-sectional diameter, and a third region extending from the fifth shoulder to the connector end, the third region having a minimum, seventh cross-sectional diameter that is greater than the minimum, sixth cross-sectional diameter.

A sixth aspect of the present invention provides a system for covering a first connector adapted to terminate a first cable, and further covering a second connector adapted to terminate a second cable, the system comprising: (i) a first elongated body member comprising cable and splice ends, interior and exterior surfaces, and extending along a longitudinal axis, the first elongated body being adapted to envelop at least a portion of the first connector; (ii) a second elongated body adapted to telescopically engage the first elongated body member in enveloping relation to the second connector, the second elongated body member comprising cable and splice ends, interior and exterior surfaces, and adapted to extend co-axially from the first body member when engaged therewith, the second elongated body being adapted to envelop at least a portion of the second connector; and (iii) wherein a portion of the first elongated body is adapted to be positioned between the interior surface of the first elongated body member and the first connector. The second elongated body can further comprise an annular flange that extends about the exterior surface thereof, an upper segment that extends upwardly from the annular flange and a lower segment that extends downwardly from the annular flange. The upper segment of the second elongated body can be formed to be positioned between the interior surface of the first elongated body member and the first connector, and the splice end of the first elongated body member can be formed to abut the annular flange when the first and second elongated bodies are engaged with one another. The first elongated body member can include one or more gripping surfaces on its exterior surface.

An seventh aspect of the present invention provides a system for covering a first connector adapted to terminate a first cable, and further covering a second connector adapted to terminate a second cable. The system of covers essentially comprises a first elongated body member extending along a longitudinal axis and comprising cable and splice ends, interior and exterior surfaces, and adapted to envelop at least a portion of the first connector; a second elongated body adapted to telescopically engage the first elongated body member in enveloping relation to the second connector. The second elongated body member adapted to envelop the second connector comprises cable and splice ends, interior and exterior surfaces, and extends co-axially from the first body member when engaged therewith, and further comprises an annular flange that extends about said exterior surface thereof, an upper segment that extends upwardly from said annular flange and a lower segment that extends downwardly from said annular flange. A portion of the upper segment of the first elongated body is adapted to be positioned between the interior surface of the first elongated body member and the first connector.

A eighth aspect of the present invention provides a cover for a connector adapted to terminate a cable, the cover comprising: (i) a unitary elongated body member having a cable end, a connector end, an interior surface, and an exterior surface; (ii) a plurality of spaced apart grooves formed in a predetermined region of the interior surface of the body member, proximate the cable end; and (ii) wherein the cable end and the connector end are positioned such that the body of the cover forms an angle greater than or less than 180 degrees. The exterior surface of the angled cable cover can further comprise first region extending from the cable end to a first shoulder and including at least one strain relief member defined therein, the first region having a minimum, first cross-sectional diameter, a second region extending from the first shoulder to a second shoulder, the second region having a minimum, second cross-sectional diameter that is less than the minimum, first cross-sectional diameter, and a third region extending from the second shoulder to the connector end, the third region having a minimum, third cross-sectional diameter that is greater than the minimum, second cross-sectional diameter.

A ninth aspect of the present invention provides a customizable port seal comprising: (i) a unitary elongated body having an initial length and comprising a cable end, a connector end, an interior surface, and an exterior surface, and a first section of arbitrary length proximate to the connector end; (ii) wherein the exterior surface of the port seal proximate to the cable end comprises one or more spaced apart grooves; and (iii) wherein at least a portion of the first section is adapted to be removed such that the unitary elongated body has a second, post-removal length which is shorter than the initial length. Optionally, the interior and/or exterior surfaces of each end of the port seal can comprise a plurality of spaced-apart grooves, where each of the grooves extends in spaced parallel relation to the others.

A tenth aspect of the present invention provides a port seal system comprising (i) a customizable port seal which includes a unitary elongated body having an initial length and comprising a cable end, a connector end, an interior surface, and an exterior surface, and a first section of arbitrary length proximate to the connector end, wherein at least a portion of the first section is adapted to be removed such that the unitary elongated body has a second, post-removal length which is shorter than the initial length; and (ii) a cover in overlapping communication with the cable end of the port seal. The cover comprises a unitary elongated body member having a cable end, a connector end, an interior surface, and an exterior surface, and a plurality of spaced apart grooves formed in a predetermined region of the interior surface of the body member, proximate to the cable end. The exterior of the cable cover in the cover system can optionally include a first region extending from the cable end to a first shoulder and including at least one strain relief member defined therein, the first region having a minimum, first cross-sectional diameter, a second region extending from the first shoulder to a second shoulder, the second region having a minimum, second cross-sectional diameter that is less than the minimum, first cross-sectional diameter, and a third region extending from the second shoulder to said connector end, the third region having a minimum, third cross-sectional diameter that is greater than the minimum, second cross-sectional diameter.

It would be advantageous to offer protective connector caps, or coaxial cable connector interface covers, to accommodate the various sizes, types, and genders of connector interfaces, without requiring a single size and type of protective cap for each size, type, and gender of connector. An interface cover for a connector is provided to lessen manufacturing systems, simplify inventory, and lessen costs. In one embodiment, the interface cover for a connector comprises a lid, a first outer sleeve extending from the lid, and a first plurality of inner fingers circumferentially spaced, arranged concentrically within the first outer sleeve and spaced apart from the first outer sleeve. The spacing between the plurality of inner fingers and the first outer sleeve is configured to provide an interference fit between at least one of the first outer sleeve and the connector, and the first plurality of inner fingers and the connector, with both a male and a female version of the connector.

In another embodiment, the interface cover for a connector comprises a lid, a first outer sleeve extending from the lid, and a first plurality of inner fingers circumferentially spaced and arranged concentrically within the first outer sleeve.

In another embodiment of the invention, the interface cover can also comprise a second outer annular wall extending from the lid in a direction opposite the direction the first outer annular wall extends from the lid, and a second plurality of inner fingers circumferentially spaced, arranged concentrically within the second outer sleeve.

An eleventh aspect of the disclosure provides a system for sealing a jumper cable and connector assembly, the system including an interface cover including a lid, and a sleeve extending from the lid, the sleeve adapted to receive the interface end of a cable connector, the sleeve having an outer surface, and a unitary elongated body including a cable end, an interface end opposite the cable end, a passageway extending from the cable end to the interface end, the cable end of the passageway adapted to elastically engage a cable, and a sealing region on an interior surface at the interface end of the passageway, the sealing region configured to sealingly receive the sleeve of the interface cover, wherein an environmental seal exists between the outer surface of the sleeve and the sealing region of the weatherproof cover.

A twelfth aspect of the disclosure provides a coaxial cable connector interface cover for use with a weatherproof cover having an inner surface, the coaxial cable connector interface cover including a lid, and an outer sleeve extending from the lid, the outer sleeve configured to establish an environmental seal at the inner surface of the weatherproof cover.

A thirteenth aspect of the disclosure provides a method of establishing an environmental seal on a jumper cable and connector assembly, the method including sliding an interface cover onto a connector, the connector having a cable end, a connector body, and an interface end, the interface cover comprising a lid and a sleeve extending from the lid, the sleeve configured to form an environmental seal at an inner surface of a weatherproof cover, sliding the weatherproof cover over the connector and the sleeve, the weatherproof cover comprising a cavity configured to surround the cable end and the connector body of the connector, the cavity being open at the interface end of the connector, wherein an environmental seal is formed around the connector.

A fourteenth aspect of the disclosure provides a system for sealing the terminal end of a cable including a removable cap including a lid, and a sleeve extending from the lid, the sleeve having an outer surface, and a cable cover including a cable end adapted to elastically engage a cable, a cap end opposite the cable end, and a sealing region configured to overlappingly receive the sleeve of the removable cap, wherein an environmental seal is formed between the outer surface of the sleeve and the overlapping sealing region of the cable cover.

### BRIEF DESCRIPTION OF THE DRAWINGS

The present invention will be more fully appreciated and understood by reading the following Detailed Description in conjunction with the accompanying drawings, in which:

FIG. 1 is a partially cut-away perspective view of a first embodiment of a cover for a first cable connector;

FIG. 2 is a partially exploded perspective view thereof;

FIG. 3 is a fully exploded perspective view thereof;

FIG. 4 is a partially cut-away perspective view of a second embodiment of a cover for a second cable connector;

FIGS. 5 and 6 are partially exploded perspective views thereof;

FIG. 7 is a fully exploded perspective view thereof;

FIG. 8 is a partially cut-away perspective view of a third embodiment of a system of covers for providing cover to first and second cable connectors used to splice two differently sized cables;

FIG. 9 is a partially exploded perspective view thereof;

FIG. 10 is a fully exploded perspective view thereof;

FIG. 11 is a partially cut-away perspective view of a fourth embodiment of a system of covers for providing cover to first and second cable connectors used to splice two differently sized cables;

FIGS. 12 and 13 are partially exploded perspective views thereof;

FIG. 14 is a fully exploded perspective view thereof;

FIG. 15 is an exploded view of a sixth embodiment of a cover and cable connector assembly;

FIG. 16 is a side view of an assembled configuration thereof;

FIGS. 17-19 are partially cut-away perspective views of a seventh embodiment of a system of covers for providing cover to first and second cable connectors used to splice two differently sized cables;

FIG. 20 is a partially cut-away perspective view of a eighth embodiment of a system of covers for providing cover to first and second cable connectors and using an adaptor;

FIG. 21A is a side view of a first embodiment of an adaptor;

FIG. 21B is a bisecting cut-away view of one embodiment of the adaptor;

FIG. 21C is a bisecting cut-away view of another embodiment of the adaptor;

FIG. 22 is a partially cut-away perspective view of a ninth embodiment of a system of covers for providing cover to first and second cable connectors and using an adaptor;

FIGS. 23-25 are partially cut-away perspective views of a tenth embodiment of a system of covers for providing cover to first and second cable connectors and using an adaptor;

FIG. 26 is a cut-away perspective view of a eleventh embodiment of a cover for a cable connector;

FIG. 27 is a cut-away side view of a twelfth embodiment of a cover for a cable connector prior to installation;

FIG. 28 is a cut-away side view of the same embodiment of the cover, after installation over a connector;

FIG. 29 is a side view of a system comprising a cable cover and a port seal of customizable length;

FIG. 30 is a side view of two port seals of different lengths according to one embodiment of the present invention;

FIG. 31 is a perspective view of a bulkhead with a port seal;

FIG. 32 is a side view of two port seals of different lengths according to one embodiment of the present invention;

FIG. 33 is a side view of two port seals of different lengths with cable covers;

FIG. 34 is a perspective view of an adjustable port seal; and

FIG. 35 is a side view of an adjustable port seal.

FIG. 36 depicts a side perspective view of a protective connector cap for a DIN-type connector, according to one embodiment of the invention;

FIG. 37 depicts a front plan view of the protective connector cap of FIG. 36;

FIG. 38 depicts an exploded cross-sectional view of the protective connector cap of FIG. 36 and a male DIN-type connector;

FIG. 39 depicts an exploded cross-sectional view of the protective connector cap of FIG. 36 and a female DIN-type connector;

FIG. 40 depicts a cross-sectional view of the protective connector cap of FIG. 36 engaged with a male DIN-type connector;

FIG. 41 depicts a cross-sectional view of the protective connector cap of FIG. 36 engaged with a female DIN-type connector;

FIG. 42 depicts a side perspective view of a protective connector cap for a N-type connector, according to another embodiment of the invention;

FIG. 43 depicts a front plan view of the protective connector cap of FIG. 42;

FIG. 44 depicts an exploded cross-sectional view of the protective connector cap of FIG. 42 and a male N-type connector;

FIG. 45 depicts an exploded cross-sectional view of the protective connector cap of FIG. 42 and a female N-type connector;

FIG. 46 depicts a cross-sectional view of the protective connector cap of FIG. 42 engaged with a male N-type connector;

FIG. 47 depicts a cross-sectional view of the protective connector cap of FIG. 42 engaged with a female N-type connector; and

FIG. 48 depicts a cross-sectional side view of a protective connector cap according to yet another embodiment of the invention.

FIG. 49 depicts a side perspective view of an interface cover for a DIN-type connector, according to one embodiment of the invention;

FIG. 50 depicts a front plan view of the interface cover of FIG. 49;

FIG. 51 depicts an exploded perspective view of an embodiment of the elongated cover and the interface cover in an assembly; and

FIG. 52 depicts a side perspective view of the cable cover assembly of FIG. 51.

### DETAILED DESCRIPTION

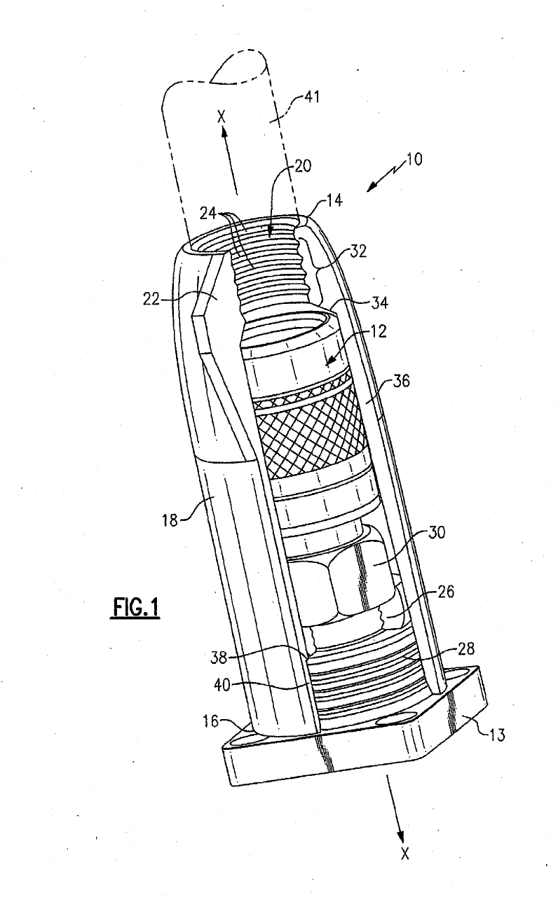

Referring now to the drawing figures in which like reference numerals refer to like parts throughout, there is seen in FIG. 1 a cover, designated generally by reference numeral 10, adapted to be placed in secure and sealing relation over a connector 12 (such as a 5-series connector manufactured by John Mezzalingua Associates, Inc. of East Syracuse, N.Y. that is adapted to terminate a ⅞″ cable). Connector 12 terminates on a bulkhead 13. In the embodiment of FIG. 1, cover 10 comprises an elongated body composed of a rubber material that exhibits a low modulus of elasticity over an extended temperature range, preferably a silicone rubber, that extends along a longitudinal axis X-X, a cable end 14, bulkhead end 16, exterior surface 18, interior surface 20, and wedge shaped wings 22 extending from opposing sides of exterior surface 18 that provide a gripping surface for a tool or manual engagement, such as pliers or a user's fingers, used to remove cover from covering relation to connector 12. The rubber composition of the cover permit it to elastically deform to the connector and other elements that it covers (e.g., the bulkhead, an interface cover, or an adaptor), as will be described in greater detail hereinafter, when being installed or removed. The interior surface 20 defines a passageway extending through the body between the cable end 14 and the bulkhead end 16.

A series of longitudinally and sequentially spaced grooves 24 are formed in interior surface 20, proximate cable end 14, and extend over a predetermined distance. Notably, grooves 24 are not threads as they are not a continuous helix, but rather spaced apart, parallel grooves that function as small reservoirs for any moisture that may infiltrate the open cable end 14 of cover 10, as will be described in greater detail hereinafter. In the field, scratches or other material removal occurs in the jacket of a cable, and moisture may sometimes infiltrate through those scratches and into the seal. Grooves 24 (and the grooves in the other disclosed embodiments) are intended to minimize the effects of any such moisture migration.

With continued reference to FIG. 1, connector 12 extends outwardly from bulkhead 13 along axis X-X. Bulkhead 13 includes a shank portion 28 that is either integral therewith or comprised of a separate element preferably composed of rubber. If shank portion 28 is integral with bulkhead 13, a rubber gasket 26 is preferably placed in sealing relation at the interface of shank portion 28 and the neck 29 of bulkhead 13. Shank portion 28 is of a diameter having a dimension at least as large as, and preferably larger than the maximum width of coupling element/nut 30 (which is the next widest part of the connector), thus creating the connector's maximum width dimension at the interface of connector 12 and bulkhead 13.

The interior surface 20 of cover 10, which defines a passageway of various diameters, includes a first region 32 that is of an essentially constant cross-sectional diameter and extends from cable end 14 to a first shoulder 34 from which it then tapers uniformly (although a stepped shoulder could apply equally) increasing the interior diameter to a second (medial) region 36 of interior surface 20 where it again remains essentially constant for a predetermined length. Second region 36 tapers outwardly (although it could be stepped instead of tapered) at a second shoulder 38 to a third region 40 that extends at a uniform cross-sectional diameter for the remainder of the cover's length until terminating at bulkhead end 16. These distinct regions of respective cross-sectional diameters securely envelop connector 12 and form seals at multiple points along the connector as will be described hereinafter.

To use cover 10, the cover would first be fully slid (cable end 14 first) over a cable 41 that is to be terminated in connector 12, leaving the terminal end of cable 41 exposed. As the cover is designed to have an interference fit with cable 41, it may be useful to apply a small amount of grease to the outside of the cable jacket to assist in pulling the cover over the cable. Cable 41 may then be terminated and attached to connector 12 in a conventional manner. Cover 10 would then be manually slid over connector 12 until its bulkhead end 16 preferably abuts, but at least overlapping with bulkhead 13. When cover 10 is fully positioned over connector 12, first region 32 tightly enwraps cable 41 with shoulder 34 positioned adjacent the terminating end of connector 12, thereby forming a seal between cable 41 and cover 10. If moisture does infiltrate the seal formed between cable 41 and cover 10 (due, for instance, to scratches or other removal of material that often occurs with the cable's jacket), the grooves 24 in first region 32 function as small reservoirs. Medial region 36 extends in tightly covering relation to the majority of connector 12, including its coupling element/nut 42 (although illustrated as a nut, various types of coupling elements are conventionally used on cable connectors of the type herein described) and the interface ring 44 that interfaces connector 12 with bulkhead 13, with a seal being formed at the junction of the interface ring 44 and medial region 36. Shoulder 38 tapers outwardly (Although it could be stepped instead of tapered) to accommodate shank portion 28 with third region 40 adapted to cover the shank portion 28 until the corner terminates in abutting relation to bulkhead 13, with seals being formed between shank portion 28 and cover 10 and between bulkhead 13 and cover 10.

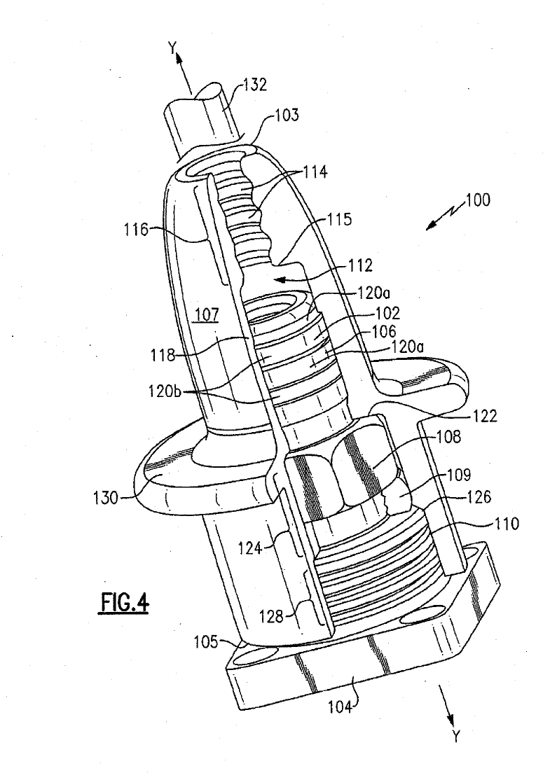

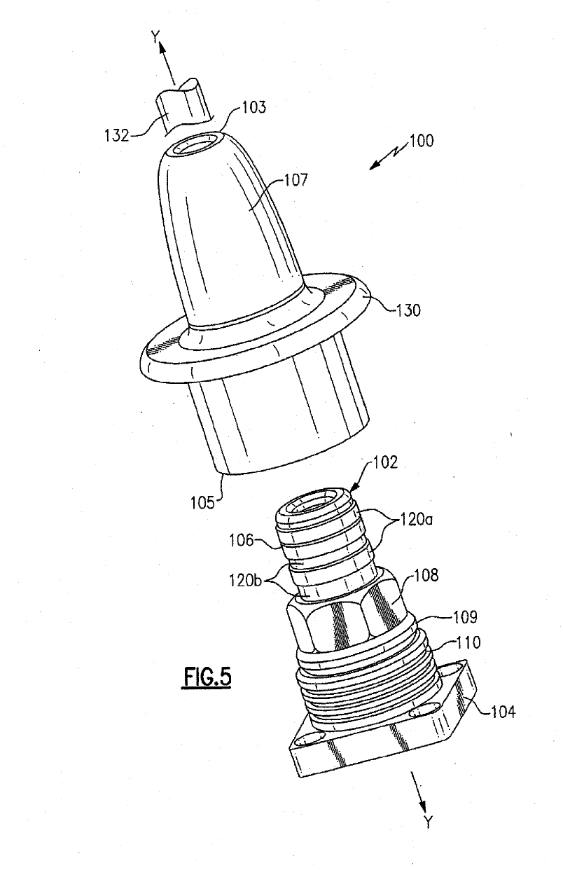

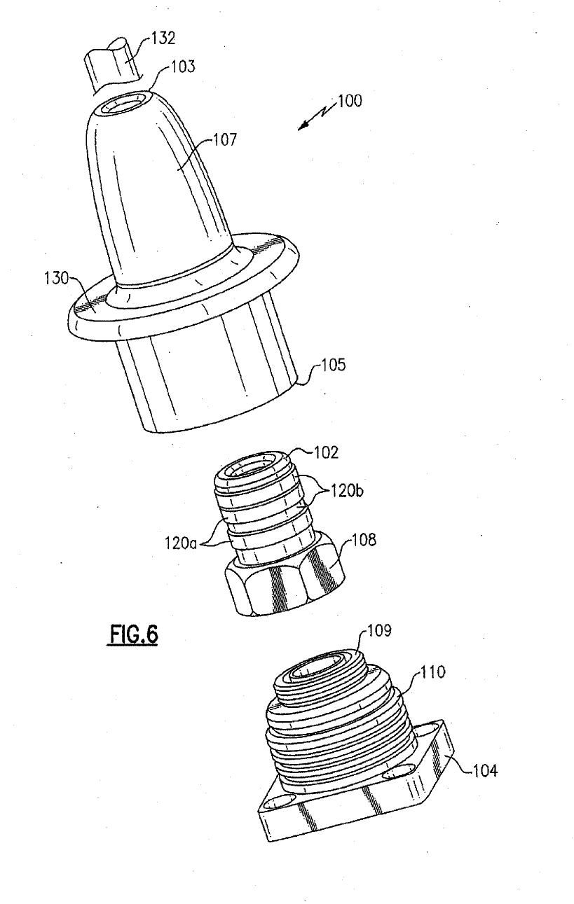

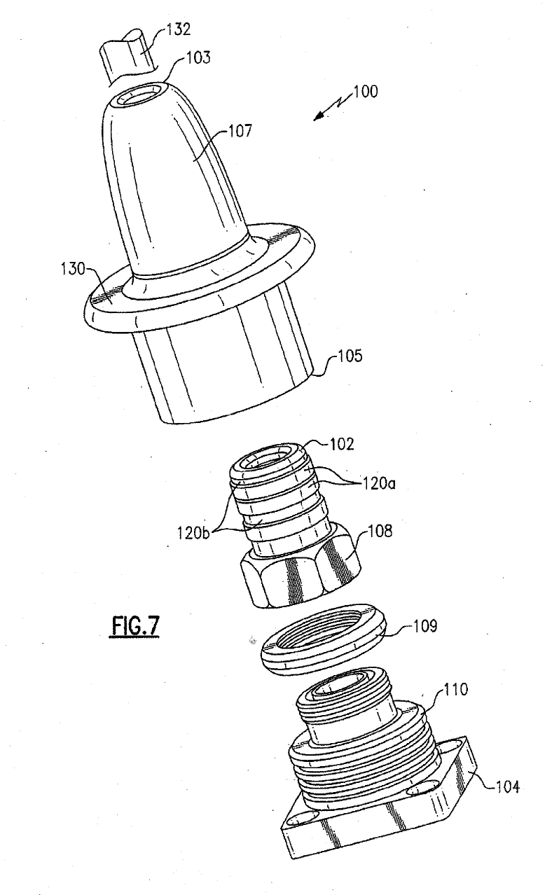

With reference to FIGS. 4-7, an embodiment of a second cover 100 is provided. Cover 100, like cover 10, is adapted for placement in secure and sealed covering relation over a connector 102 (such as a series 4 connector, manufactured and sold by John Mezzalingua, Associates, Inc.) that is for use with a smaller cable (e.g., ½″) than is connector 12. However, cover 100, like cover 10, is adapted to envelop a connector that terminates in a bulkhead 104. Connector 102 comprises a connector portion 106, a coupling element/nut 108 (although illustrated as a nut, various types of coupling elements are conventionally used on cable connectors of the type herein described), and interface ring 109 and an enlarged shank portion 110 (that, like shank portion 26, may be integral with or a separate, preferably rubber, element; if integral, a rubber gasket would preferably be placed at the interface of the shank portion and connector), and bulkhead 104.

Connector 100 comprises cable and bulkhead ends 103, 105, respectively, exterior and interior surfaces 107, 112, respectively, and a series of grooves 114 formed in longitudinally spaced relation to one another in interior surface 112 proximate, cable end 106. Grooves 114 serve as reservoirs in the event of moisture migration through cable end 106 to assist in preventing the moisture from leaching into connector 102.

The interior surface 112 of cover 100 includes a first region 116 of an essentially constant diameter that extends from cable end 106 to a first shoulder 115 from which it steps outwardly to an increased cross-sectional diameter that extends essentially uniformly in a second or medial region 118. Notably, the portion of connector 102 that second region 118 is adapted to cover comprises different diameter rings 120a and 120b with 120a being of slightly smaller diameter than 120b. The diameter of second region 118 approximates that of rings 120a and the pliable nature of cover 100 permits the material to deform to accommodate the relevant portion of connector 102 and consequently securely envelop the larger diameter rings 120b, creating tight seals at the transitions between rings 120a and 120b. Medial region 118 next steps outwardly at a shoulder 122 to a third (also medial) region 124 that is adapted to be positioned in covering relation over nut 108 and interface ring 109. Third region 124 then steps outwardly at shoulder 126 to a fourth region 128 that is adapted to envelop shank portion 110 and terminate at bulkhead 104.

Unlike the wings 22 of cover 10, cover 100 includes a ring 130 that extends around exterior surface 107 in a plane that is essentially transverse to the longitudinal axis Y-Y of cover 100 and is positioned at about the midpoint along the length of cover 100. Ring 130 serves principally as a drip edge to direct any rain water or other moisture away from the interfaces between the cover and the connector/cable. Ring 130 could also serve to provide a gripping surface for a tool used to remove cover 100 from connector 102.

The manner of using cover 100 is the same as that for cover 10; namely sliding cover 100 (cable end first) entirely over a cable 132, and then terminating the cable in connector 102 in a conventional manner. Cover 100 is then slid downwardly in enveloping relation to connector 102 until its distal end 108 preferably abuts, but at least overlaps with bulkhead 104. When cover 100 is fully positioned over connector 102, first region 116 tightly enwraps cable 132 with shoulder 115 positioned adjacent the terminating end of connector 102, thereby forming a seal between cable 132 and cover 100. If moisture does infiltrate the seal formed between cable 132 and cover 100, the grooves 114 function as small reservoirs. Second region 118 extends in tightly covering relation to the majority of connector 102 that extend outwardly from nut 108, with shoulder 120 positioned in sealed relation to nut 108. Third region 124 then extends in sealed relation to nut 108 and interface ring 109, and shoulder 126 tapers (or steps) outwardly such that fourth region 128 can accommodate and extend in sealed relation to shank portion 110 until it terminates in abutting relation to bulkhead 104, with seals being formed between shank portion 110 and cover 100 and between bulkhead 104 and cover 100.

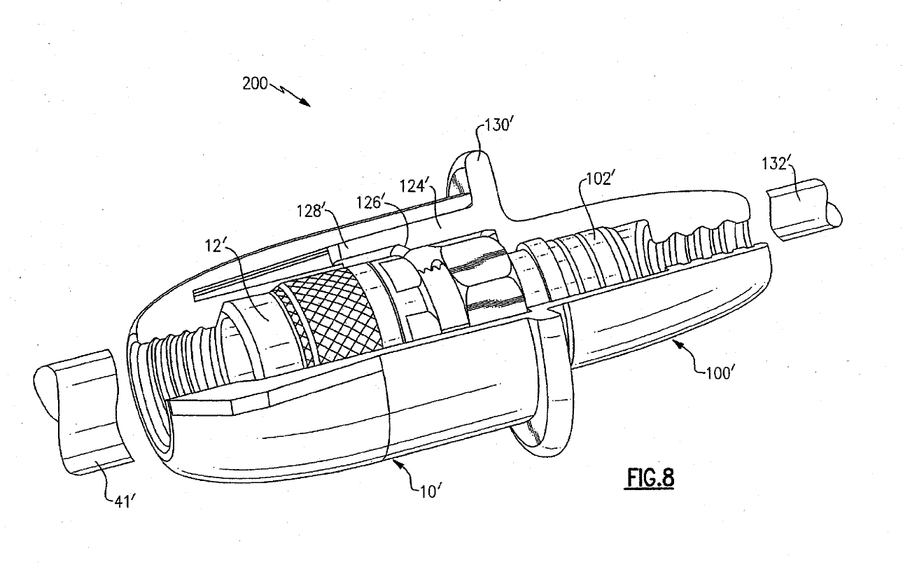

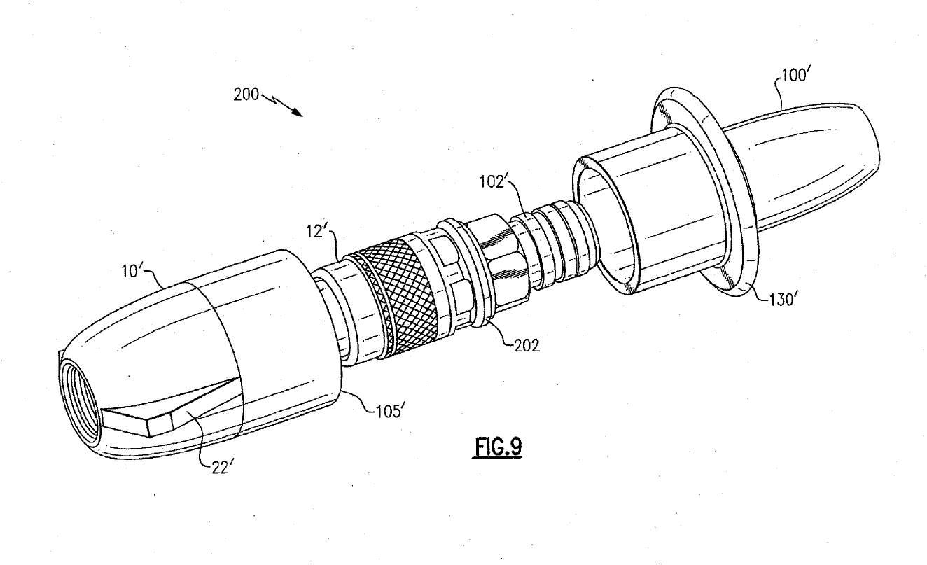

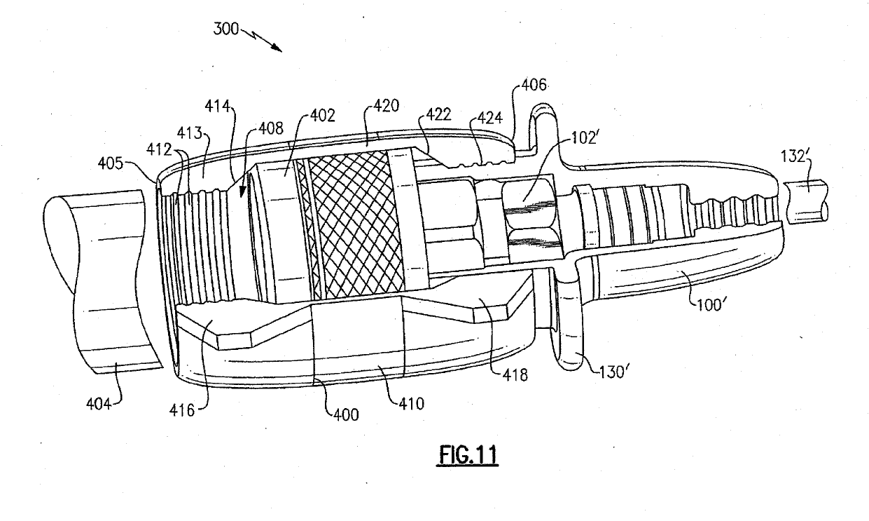

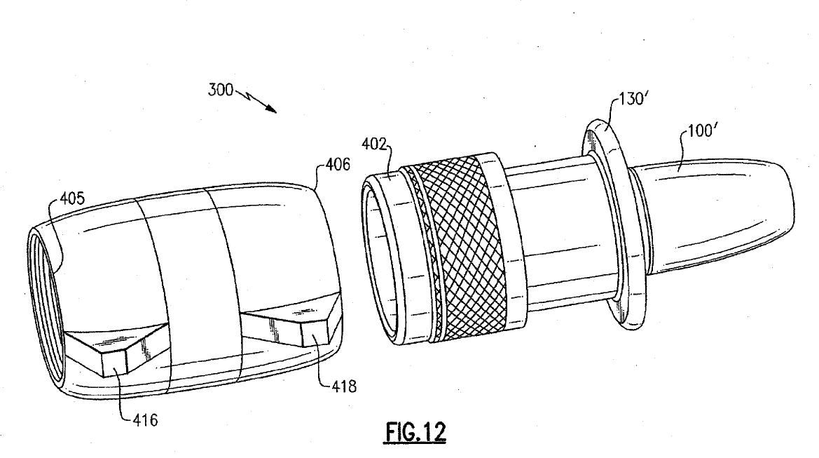

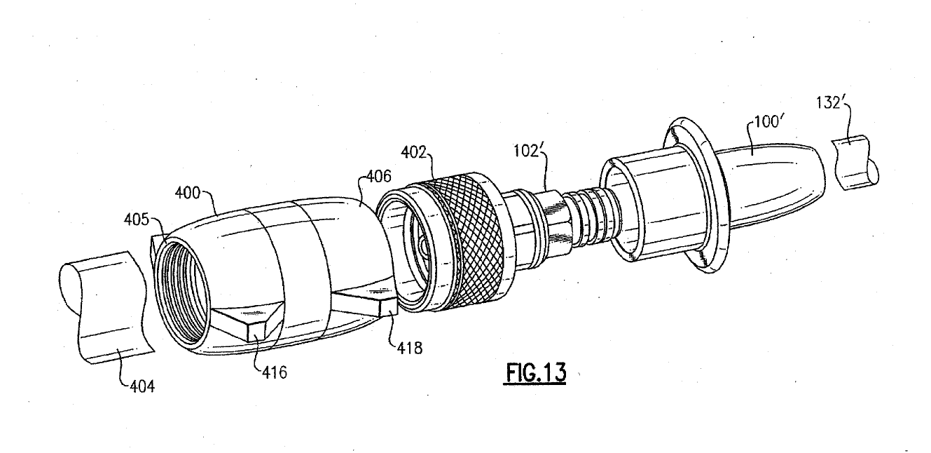

While covers 10 and 100 are both adapted to be placed in covering relation to connectors that terminate in a bulkhead, with reference to FIGS. 8 to 14 there is seen a system for covering a pair of connectors that are used to splice together two differently sized cables. FIGS. 8-10 illustrate a system 200 of using covers 10 and 100 (that will be designated 10′ and 100′ for purposes of differentiating the bulkhead embodiments from the splice embodiment) to splice cables that terminate in connectors 12′ and 102′ (again, the connectors 12′ and 102′ are structurally the same as connectors 12 and 102 with the difference being the lack of a bulkhead for terminating the connectors since the connectors are joined together). The structures of covers 10′ and 100′ are the same as described above for covers 10 and 100, but with a different method of use and resultant arrangement.

System 200 comprises cover 10′ adapted to cover connector 12′ and cover 100′ that is adapted to cover connector 102′. In use, cover 10′ is first slide entirely over cable 41′ which may then be terminated to connector 12′ in a conventional manner, and likewise, cover 100′ may be slid over cable 132′ which may then be terminated to connector 102′. Next, connectors 12′ and 102′ are interconnected by applying an appropriate amount of torque to secure the interconnection, with a gasket 202 optionally being positioned between the two to enhance the sealing at the interface of the connectors. Cover 100′ may then be slid downwardly into enveloping relation to connector 102′. Finally, cover 10′ may be slide over connector 12′ with fourth region 128′ and at lest a portion of third region 124′ of cover 100′ being telescopically engaged within third region 40′. In addition to the seals created by covers 10′ and 100′ as previously described, an additional seal is created at the interface of end 105′ and cover 100′.

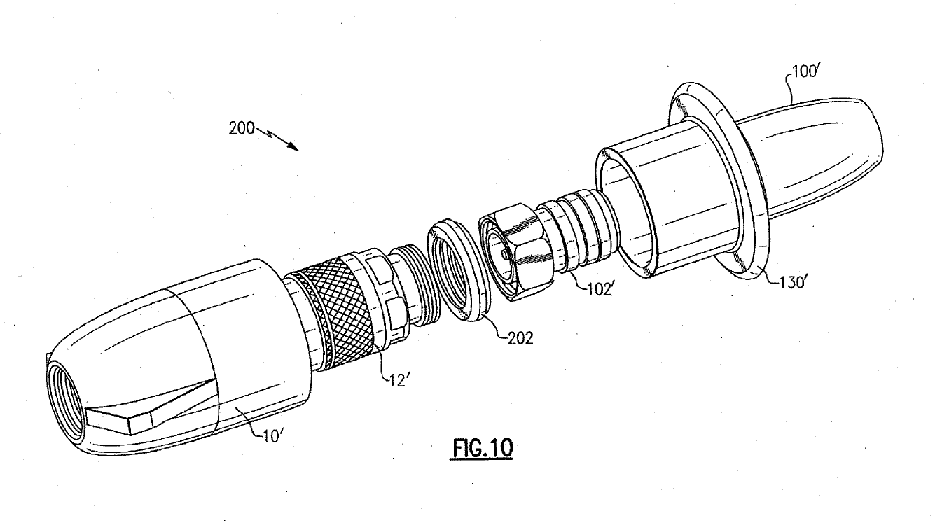

System 300, illustrated in FIGS. 11-14, comprises a cover 400 that is adapted to cover a connector 402 (such as a series 7 connector manufactured by John Mezzalingua Associates, Inc.) in which a cable 404 (e.g., a 1⅝ cable) may be terminated, and cover 100′ that provides, as previously described, cover for connector 102′ that in this embodiment is adapted to be spliced to connector 402. With regard to cover 400, it comprises cable and splice ends 405, 406, respectively, and interior and exterior surfaces 408, 410, respectively. A series of grooves 412 are formed in interior surface 408 in parallel spaced relation to one another in the first region 413 of cover 400 that extends from cable end 408 to a first shoulder 414. Grooves 412, like the other grooves described herein, serve as reservoirs for any moisture that migrate into cover 400 at its interface with cable 404.

While cover 10 includes axial symmetric wings 22, cover 400 includes two sets of axially symmetric positioned wings 416 and 418 that provide gripping surfaces for a tool to assist in pulling cover 400 off connector 402 or pull it into covering relation to connector 402. The extra set of wings is provided due to the larger size cable 404 and connector 402 that cover 400 is adapted to seal as compared to those associated with cover 10, but also permits this cover to be installed in either orientation (as it is symmetrical about its transverse mid-plane). Interior surface 408 of cover 400 comprises three distinct regions: first region 413, (second) region 420 that extends from shoulder 414 to a second shoulder 422, and a third region 424 that extends between shoulder 422 and splice end 406. Shoulder 414 tapers outwardly from first region 413 to second region 420 which then extends with an essentially constant cross-sectional diameter, and shoulder 422 then tapers back inwardly where third region 424 then continues with an essentially constant cross-sectional diameter. The tapering of shoulders assists in the removal and installation of cover 400 (by providing a draft), but it is conceivable that the shoulders be stepped instead of tapered.

In use, cover 400 is slid fully over cable 404, while cover 100′ is slid over cable 132′. Cover 100′ may then be slid over connector 102 in the manner previously described, and cover 400 may be slid over connector 402 such that first region 413 envelops cable 404, second region 420 is positioned in covering relation to connector 420 and third region 424 engulfs (or telescopically engages with) the exterior surface of the lower portion of cover 100′ with splice end 406 abutting or nearly abutting ring 130′.

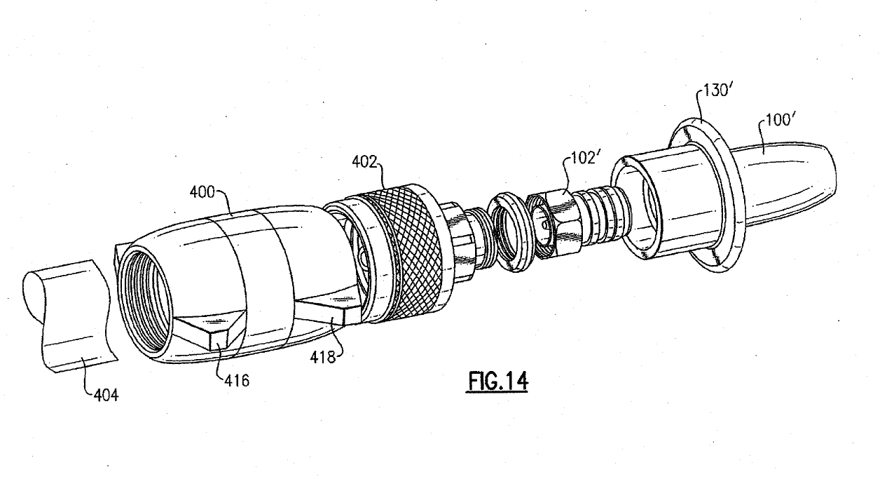

In another embodiment of the cable cover, the cover comprises two or more distinct exterior regions. FIG. 15 depicts a cover 10 adapted to be placed in secure and sealing relation over a connector 12 (such as a 5-series connector manufactured by John Mezzalingua Associates, Inc. of East Syracuse, N.Y. that is adapted to terminate a ⅞″ cable). Similar to other embodiments, connector 12 terminates on a bulkhead 13. In the embodiment of FIG. 15, cover 10 comprises: an elongated body composed of a rubber material that exhibits a low modulus of elasticity over an extended temperature range, preferably a silicone rubber, that extends along a longitudinal axis X-X; a cable end 14; bulkhead end 16; exterior surface 18; interior surface 20; and an annular groove 222 of reduced diameter (when compared to the other sections of cover 10 as defined below) formed at a medial position in exterior surface 18. The rubber composition of the cover 10 permits it to elastically deform to the connector and other elements that it covers (e.g., the bulkhead), as will be described in greater detail hereinafter, when being installed or removed. In addition, the reduced diameter of medial section 222 provides a suitable gripping area for a gripping tool or fingers when installing cover 10 on a connecter 12.

Cover 10 further comprises a cable end region 224 positioned on the cable receiving side of groove 222, and a bulkhead end region 226 positioned on the bulkhead side of groove 222. The cable end region 224 includes a plurality of strain relief grooves 228 formed therein with each groove 228 extending less than entirely around the circumference of exterior surface 18, although it should be noted that a single strain relief may be suitable in a particular application and the groove could extend entirely around the circumference. In one embodiment, two of the grooves are disconnected from one another by a gap between their ends, and are formed around the circumference of exterior surface in a common plane that extends transverse to the longitudinal axis X-X. In one embodiment, cable end region 224 is provided with a plurality of strain relief grooves 228 formed in co-planar pairs around exterior surface 18 and with each pairing extending in laterally spaced, parallel planes to one another.

Grooves 228 serve several purposes. Due to the interference type fit of cover 10 over connecter 12, the material removal required to form grooves 228 facilitates easier stretching of the cover over the connector due to less surface contact, and hence friction, during the covering process. Grooves 228 further permit cover 10 to bend in the areas of grooves 228, thereby providing strain relief when the cable (not shown) is bent.

Bulkhead end region 226 comprises a series of grooves 230 formed entirely circumferentially around exterior surface 18 in spaced, parallel relation to one another. In this embodiment of the present invention, grooves 230 provide reservoirs in which liquid may collect. In one embodiment, grooves 230 provide pressure points to engage or otherwise frictionally interact with grooves on the inner surface of another cover, as will be described in greater detail hereinafter.

As shown in FIG. 15, connector 12 extends outwardly from bulkhead 13 along axis X-X. Bulkhead 13 includes a shank portion 232 that is either integral therewith or comprised of a separate element preferably composed of rubber. If shank portion 232 is integral with bulkhead 13, a rubber gasket (not shown) is preferably placed in sealing relation at the interface of shank portion 232 and the neck of bulkhead 13. Shank portion 232 is of a diameter having a dimension at least as large as, and preferably larger than the maximum width of coupling element/nut, or interface nut, 52 (which is the next widest part of the connector), thus creating the connector's maximum width dimension at the interface of connector 12 and bulkhead 13.

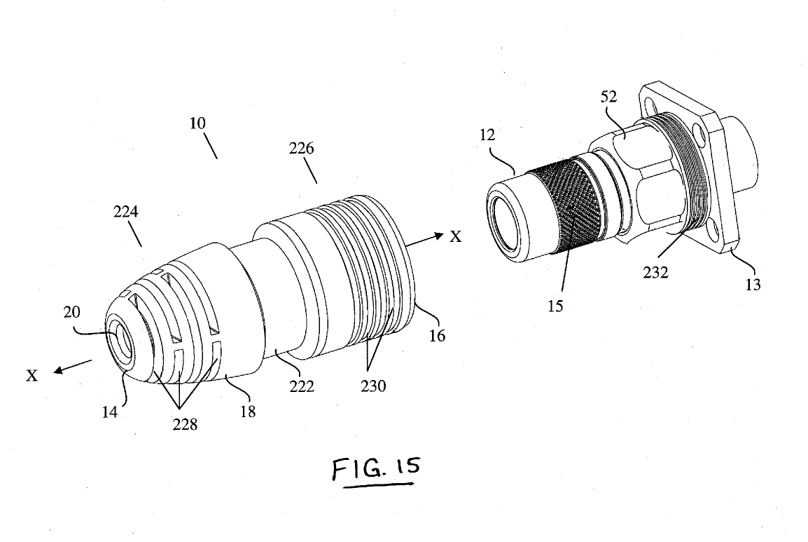

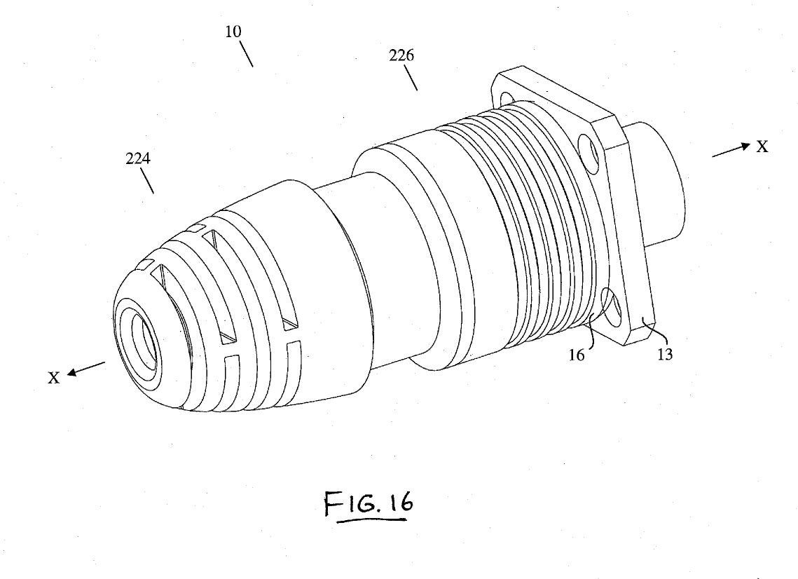

FIG. 16 depicts cover 10 fully assembled onto connector 12. In the assembled configuration, bulkhead end 16 of cover 10 is in reversible communication with bulkhead 13 to provide environmental protection.

Cover 10 (and all embodiments of the cover) is preferably pre-lubricated with a dry lubricant on its inside surface to ease the installation. Impregnating the rubber material composing the covers at the time of manufacture with an oil/grease composition is also effective in reducing the force required to install a cover over a connector.

Referring now to FIG. 17, the interior surface 240 of cover 10 includes a first region 242 that is of a serrated cross-section (and thus of continuously fluctuating diameter) and extends from cable end 14 to a first shoulder 234 from which it steps outwardly to a second region 244 of increased, essentially constant cross-sectional diameter. From this second region 244, the interior transitions outwardly via a step to the medial region's 222 interior diameter 246 where it remains essentially constant until shoulder 238 and then steps outwardly once more to a final internal region 248 that corresponds with bulkhead region 226. Region 248 is of an essentially constant cross-sectional diameter. These distinct regions of respective cross-sectional diameters securely envelop connector 12 and form seals at multiple points along the connector as will be described hereinafter.

In another embodiment of the invention, the interior surface 240 of cover 10 includes a first region 242 that extends from cable end 14, as shown in FIG. 15, to a first interior shoulder 234. This first region has a first cross-section diameter. At shoulder 234, interior surface 240 steps outwardly to a second region 44 having a second, essentially constant cross-sectional diameter. In this embodiment, the second cross-sectional diameter is larger than the first cross-sectional diameter. Looking at FIG. 15, the first interior region 242 with the first cross-sectional diameter would fit over region 15 of connector 12, and the second interior region 244 with the second cross-sectional diameter would fit over the coupling element/nut 52. These distinct regions of respective cross-sectional diameters securely envelop connector 12 and form seals at multiple points along the connector.

To use cover 10, the cover would first be fully slid (cable end 14 first) over a cable (not shown) that is to be terminated in connector 12, leaving the terminal end of the cable exposed. As the cover 10 is designed to have an interference fit with the cable, it may be useful to apply a small amount of grease to the outside of the cable jacket to assist in pulling the cover over the cable (although the preferred pre-lubricated rubber composition of cover may make such step unnecessary). The cable may then be terminated and attached to connector 12 in a conventional manner. Cover 10 would then be manually slid over connector 12 until its bulkhead end 16 preferably abuts, but at least overlaps with bulkhead 13. When cover 10 is fully positioned over connector 12, first region 224 of cover 10 tightly enwraps the cable with shoulder 234 positioned adjacent the terminating end of connector 12, thereby forming a seal between the cable and cover 10. If moisture does infiltrate the seal formed between the cable and cover 10 (due, for instance, to scratches or other removal of material that often occurs with the cable's jacket), the grooves in first region 224 function as small reservoirs. Medial region 222 extends in tightly covering relation to the majority of connector 12, including its coupling element/nut 52 (although illustrated as a nut, various types of coupling elements, or interface nut, are conventionally used on cable connectors of the type herein described) and the interface ring 244 that interfaces connector 12 with bulkhead 13, with a seal being formed at the junction of the interface ring 244 and medial region's 222 interior diameter 246. Shoulder 238 of cover 10 tapers outwardly (although it could be stepped instead of tapered) to accommodate shank portion 232, with internal region 248 adapted to cover the shank portion 232, with seals being formed between shank portion 228 and cover 10.

While cover 10 is adapted to be placed in covering relation to connectors that terminate in a bulkhead, with reference to FIGS. 17-19 there is seen a system for covering a pair of connectors that are used to splice together two differently sized cables. FIGS. 17-19 illustrate a system 60 of using covers 10 (which will be designated 500 for purposes of differentiating the bulkhead embodiments from the splice embodiment) and 510 to splice cables that terminate in connectors 12″ and 220. The structures of covers 500 and 510 can be the same as described above for cover 10, but with a different method of use and resultant arrangement.

FIG. 17 depicts covers 500 and 510 in a fully assembled configuration in system 60. In this configuration, the smaller cover 500 protects a smaller connector 12″ (such as 4-series connector manufactured by John Mezzalingua Associates, Inc. of East Syracuse, N.Y. that is adapted to terminate a ½″ cable) while the larger cover 510 protects a larger connector 220 (such as 5-series connector manufactured by John Mezzalingua Associates, Inc. of East Syracuse, N.Y. that is adapted to terminate a ⅞″ cable). To position covers 500 and 510 into the assembled configuration, cover 500 is first slid over connector 12 as described above. Cover 510 is then slid over connector 220. To form a protective seal the internal region 258 of second cover 510, which is optionally of a serrated cross-section (and thus of continuously fluctuating diameter) as shown in FIG. 18, is slid over external region 226 of cover 500. In addition to forming a protective seal, the interference fit between region 258 of second cover 510 and grooves of region 226 in cover 500 inhibits removal of either cover without the application of force specifically directed toward disassembling the assembly.

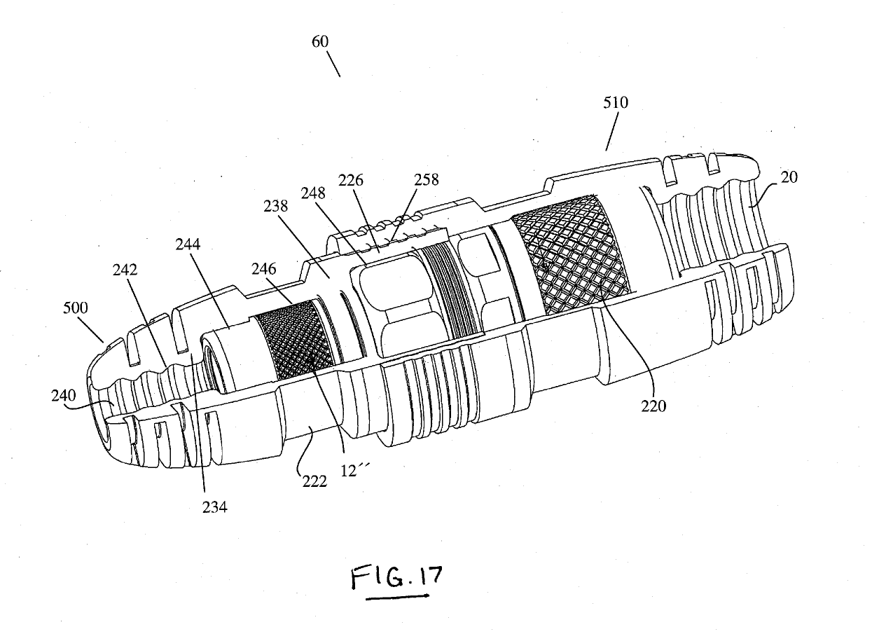

Covers 10, 10′, 100′, 400, 500, or 510 can be adapted to various configurations in order to protect the cable connector. Typically, the configuration of the cover will depend on the shape, size, or other physical characteristics of the connector. For example, in FIG. 17 internal surface 20 of second cover 510 is wider than internal surface 20 of cover 500 in order to encompass a larger connector or cable. In yet another embodiment shown in FIG. 18, region 224 of cover 510 is elongated to cover an elongated connector. In other embodiments, the cover can be as elongated as is necessary to protect the connector. FIG. 19 shows an assembled configuration in which internal region 258 of second cover 510 does not completely cover external region 226 of cover 500 due to the physical characteristics of the depicted cable connectors. The thickness of material between the external surface of the cover and the internal surfaces such as 242, 246, and 248 can also independently vary between very thin and very thick depending upon design requirements or the needs of the user.

FIG. 19 also depicts another important aspect of the present invention. As the interior of cover 500 transitions from region 246 to region 248, the cover can optionally include an annular ridge 227 that is of a similar or smaller diameter than internal region 246. During assembly, ridge 227 essentially snaps over the connector, creating yet another tight seal to further protect the cable connectors from prevent moisture and other environmental factors while inhibiting the removal of the cover without the application of force specifically directed toward disassembling the assembly.

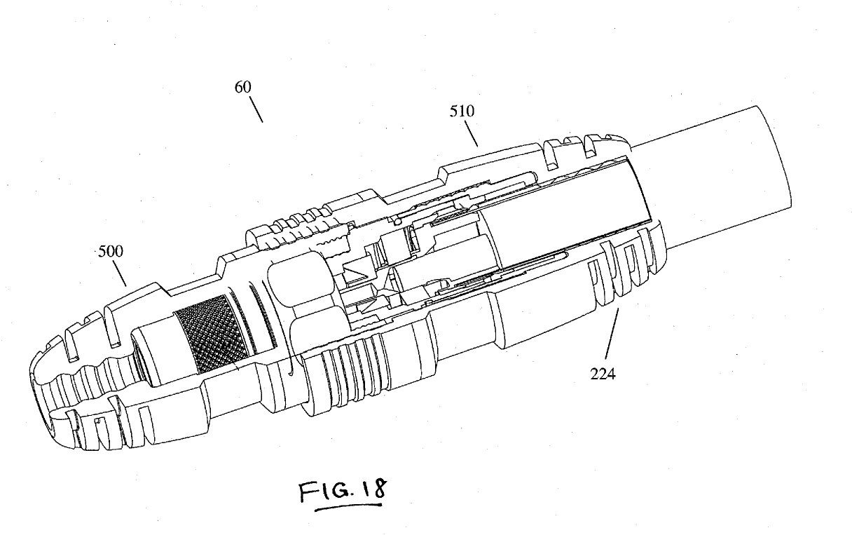

FIG. 20 depicts another embodiment of the system for covering a pair of connectors that are used to splice together two differently sized cables. In this system 62, covers 10 and 100 (which are designated 600 and 610, respectively for purposes of differentiating the bulkhead embodiments from both the splice embodiment and previous system 60) splice cables that terminate in connectors 12″ and 220′ (connectors 12″ and 120′ can be structurally the same as or similar to connectors 12, 12′, and 220 with the difference being the lack of a bulkhead for terminating the connectors since the connectors are joined together). The structures of cover 600 is the same as described above for other covers, but with a different method of use and resultant arrangement.

In contrast, the structure of cover 610 is different from the structure of the previous covers. Cover 610 is adapted to be placed in secure and sealing relation over a connector (such as a 6-series connector manufactured by John Mezzalingua Associates, Inc. of East Syracuse, N.Y. that is adapted to terminate a 1 & ¼″ cable) or another cover. In the embodiment of FIG. 20, cover 610 comprises: an elongated body composed of a rubber material that exhibits a low modulus of elasticity over an extended temperature range, preferably a silicone rubber, that extends along a longitudinal axis X-X; a cable end 264; interior surface 266; and a cable connector end 268. The interior surface 266 of cable end 264 of cover 610 includes a first region 270 that is a serrated cross-section (and thus of continuously fluctuating diameter) and extends from cable end 264 to a first shoulder 280 from which the interior surface steps outwardly to a second region 290 of increased, essentially constant cross-sectional diameter. From this second region 290, the interior transitions inwardly to shoulder 330, thence outwardly to a final region 340. The interior surface of region 340 is of an essentially constant cross-sectional diameter. These distinct regions of respective cross-sectional diameters securely envelop both connector 220′ and cover 600 to form seals at multiple points as will be described hereinafter.

FIG. 20 depicts covers 600 and 610 in a fully assembled configuration in system 62. In this configuration, the smaller cover 600 protects a smaller connector 12″ (such as 4-series connector manufactured by John Mezzalingua Associates, Inc. of East Syracuse, N.Y. that is adapted to terminate a ½″ cable) while the larger cover 610 protects a larger connector 220′ (such as 6-series connector manufactured by John Mezzalingua Associates, Inc. of East Syracuse, N.Y. that is adapted to terminate a 1 & ¼″ cable). To position covers 600 and 610 into the assembled configuration, cover 600 is first slid over connector 12″ as described above. Cover 610 is then slid over connector 220′. To form a protective seal region 340 of second cover 610 is slid over the connector region of cover 600. In addition to forming a protective seal, the interference fit between the interior surface of cover 610 and the grooves of the connector region of cover 600 inhibits removal of either cover without the application of force specifically directed toward disassembling the assembly. Furthermore, having the plurality of grooves provides redundancy in terms of inhibiting moisture migration; if one of the peaks forming grooves is sliced or otherwise compromised, moisture may infiltrate and reside in the valley of that groove (i.e., each valley provides a successive reservoir for moisture containment).

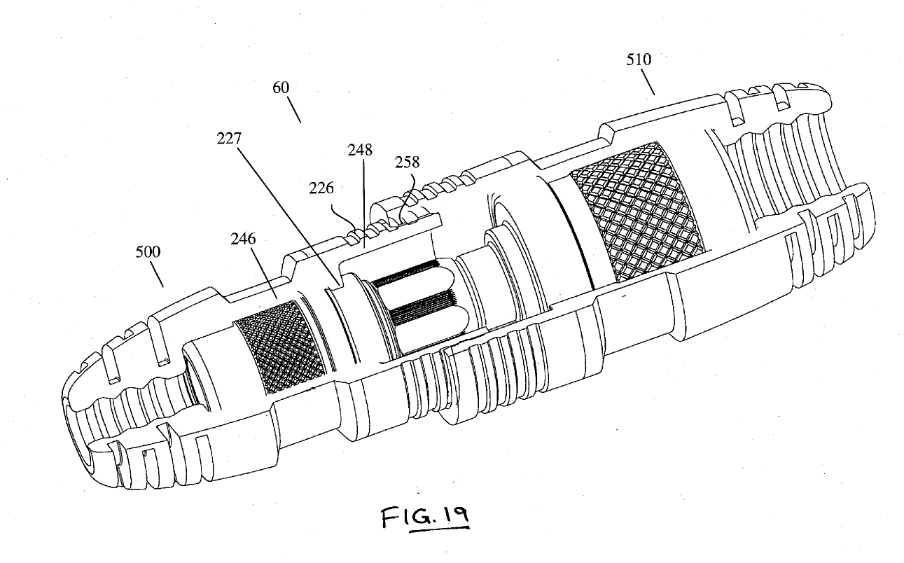

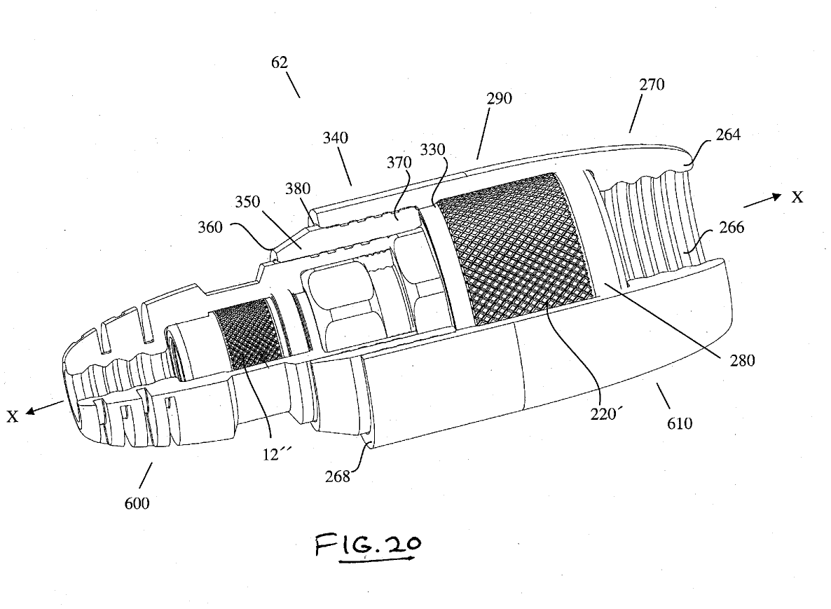

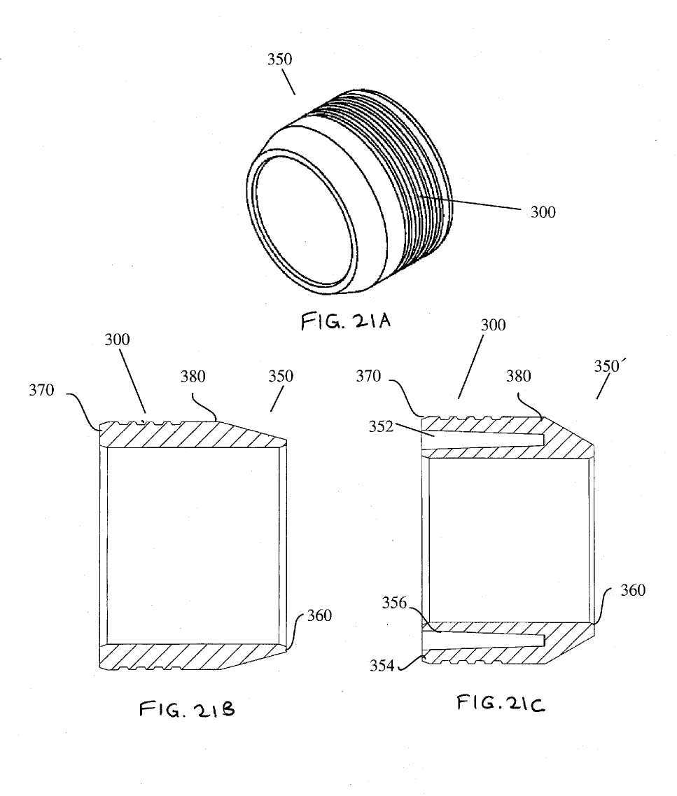

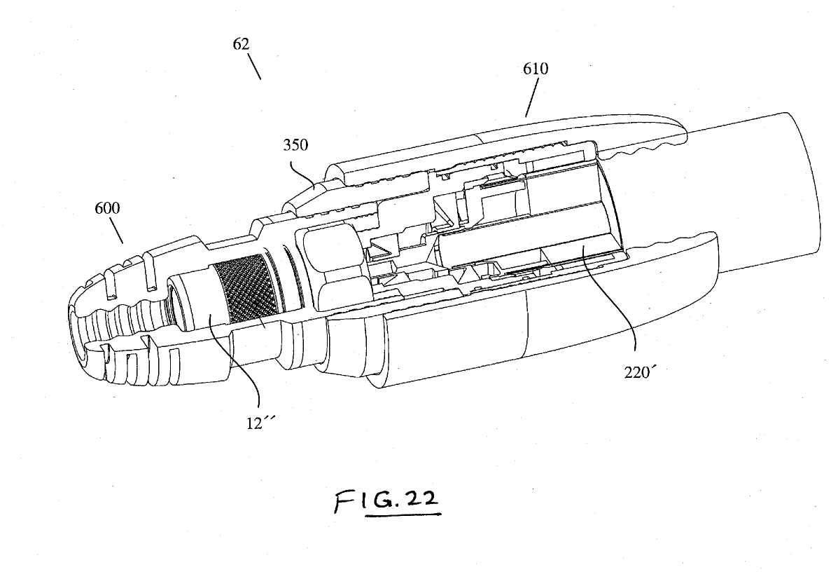

FIG. 20 also depicts an adaptor 350 used in conjunction with the cable covers to further protect the cable connectors from prevent moisture and other environmental factors. Specifically, adaptor 350 is used to fill the space left by two covers of non-interfering dimensions. For example, in FIG. 20, the interior diameter of the connector end of cover 610 is greater than the outer diameter of the connector end of cover 600, thereby creating a gap that would allow moisture to directly access the cable connectors. Adaptor 350 is used to fill that gap. As shown more clearly in FIGS. 21A and 21B, adaptor 350 comprises: an elongated body composed of a hard plastic material (e.g., glass filled nylon), although other materials, including metal, could be used, that has a higher modulus of elasticity than the elastomeric rubber material of the covers and that extends along a longitudinal axis X-X; a first end 370; and a second end 360. The exterior surface of the adaptor defines a region 300 which extends from first end 370 to a first shoulder 380. Region 300 is of serrated cross-section (and thus of continuously fluctuating diameter). In one embodiment of the adaptor, the diameter of the exterior surface gradually decreases from a maximum diameter at shoulder 380 to a minimum diameter at second end 360, although many other designs are possible.

To position the covers and adaptor 350 into the assembled configuration shown in FIG. 20, cover 600 is first slid over connector 12″ as described above. The adaptor is then fully slid over cover 600, with second end 360 of the adaptor sliding over the connector end of cover 600 (although the adaptor could alternatively be slid onto the cable end of cover 600, with first end 370 of the adaptor sliding onto the cover first). In this configuration, the interference fit between the interior surface of adaptor 350 and the grooves of the connector region of cover 600 inhibits removal of the adaptor without the application of force specifically directed toward disassembling the assembly (the differing material compositions of adapter 350 and any of the covers does facilitate movement with slightly less force than would be required if the adapter was also composed of the same elastomeric material as the covers). Cover 610 is then slid over connector 220′. To form a protective seal, region 340 of second cover 610 is slid over the region 300 of adaptor 350. In addition to forming a protective seal, the interference fit between the interior surface of cover 610 and the serrated exterior surface of region 300 of the adaptor inhibits removal of either cover without the application of force specifically directed toward disassembling the assembly.

FIGS. 21C and 23 show another embodiment of adaptor 350 (hereinafter referred to as 350′). In this embodiment, adaptor 350′ comprises: an elongated body composed of a hard plastic material, that extends along a longitudinal axis X-X; a first end 370; and a second end 360. The exterior surface of the adaptor includes a first region 300 that extends from first end 370 to a first shoulder 380, and which is of a serrated cross-section (and thus of continuously fluctuating diameter). In one embodiment of adaptor 350′, the diameter of the exterior surface gradually decreases from a maximum diameter at shoulder 380 to a minimum diameter at second end 360. The first end 370 of adaptor 350′, however, is structurally different from that of the previous embodiment of the adaptor. The elongated body of adaptor 350′ defines a cavity 352 that begins at shoulder 380 and terminates at first end 370. At shoulder 380, the elongated body of the adaptor bifurcates into a larger outer circumferential flexible body 354 and a smaller inner circumferential flexible body 356, which are separated by cavity 352. Additionally, the distance between outer body 354 and inner body 356 (and thus the size of cavity 352) increases gradually from a minimum first distance at shoulder 380 to a maximum distance at first end 370.

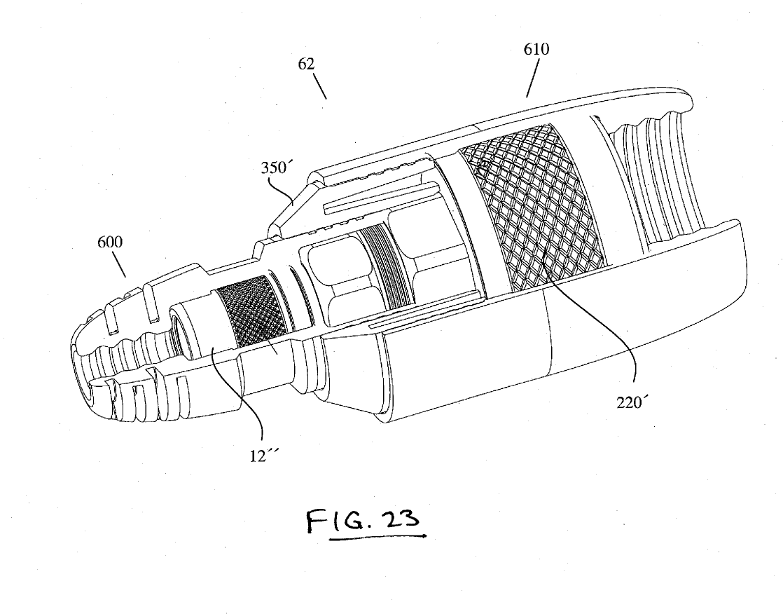

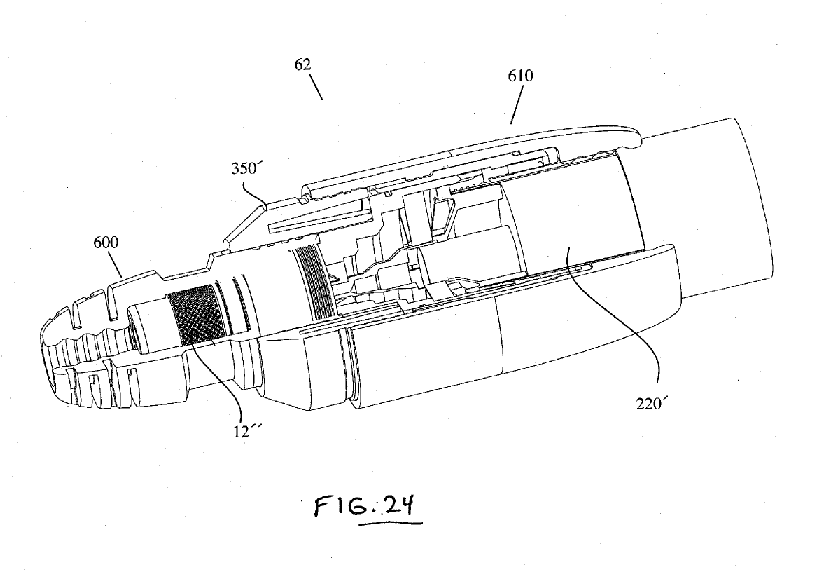

In use, adaptor 350′ in FIGS. 21C and 23 serves to fill the space left by two covers of non-interfering dimensions, as described above. The bifurcated structure and cavity of adaptor 350′ allows the adaptor to fill a wider variety of gaps using a wider variety of covers. For instance, while some covers will completely encompass the outer serrated surface of adaptor 350′ (see, e.g. FIG. 23), other covers will only partially encompass the outer serrated surface of the adaptor (see, e.g. FIG. 24), typically as a result of the underlying cable connectors. Adaptor 350′ allows the serrated outer surface to adapt to both configurations. Additionally, if the inner circumference of the connector end of cover 610 is smaller than the outer circumference of adaptor 610, the cavity of the adaptor can be compressed during assembly to allow cover 610 to slide over the adaptor. Adaptor 350′ is positioned into the assembled configuration depicted in FIG. 23 as described above.

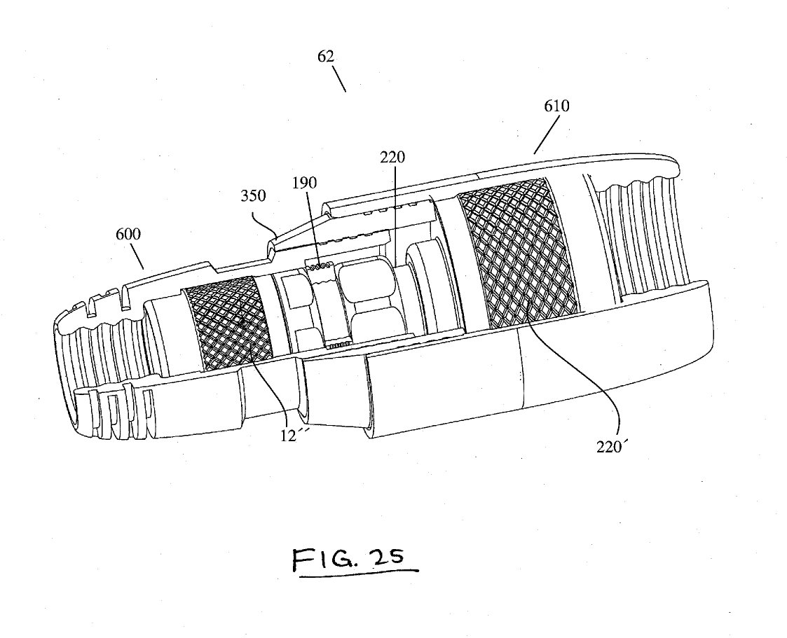

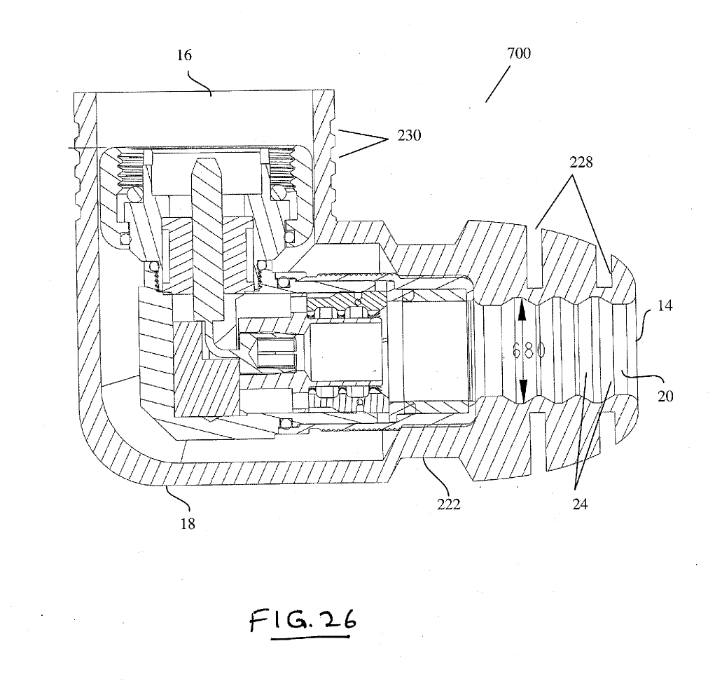

FIG. 26 depicts yet another embodiment of cover 10 adapted to be placed in secure and sealing relation over a connector 12. In this embodiment, cover 10 (hereinafter designated cover 700 to differentiate it from previous embodiments) comprises: an elongated body composed of a flexible material that exhibits a low modulus of elasticity over an extended temperature range, preferably a rubber material, a cable end 14, connector end 16, exterior surface 18, and an interior surface 20.

Unlike all previous embodiments in which the cover extends along a longitudinal axis (see, for example, the longitudinal X-X axis in FIG. 1), cover 700 can be designed to cover angled connectors, as shown in FIG. 26. Although the embodiment depicted in FIG. 26 covers hardware positioned such that the axis of cable end 14 and the axis of connector end 16 of cover 700 are at or near a 90° angle respective to one another, it should be noted that any angle greater than or less than a straight 180° angle (as shown in FIG. 25, for example) is possible. Cover 700 can either be designed to be flexible such that it covers all possible angles, or it can be produced to cover hardware of specific or approximate angles.

In one embodiment, cover 700 further comprises an annular groove 222 of reduced diameter (when compared to the other sections of cover 10 as defined below) formed at a medial position in exterior surface 18. The rubber composition of the cover 10 permits it to elastically deform to the connector and other elements that it covers (e.g., the bulkhead, an interface cover, or an adaptor), as will be described in greater detail hereinafter, when being installed or removed. In addition, the reduced diameter of medial section 222 provides a suitable gripping area for a gripping tool or fingers when installing cover 10 on a connector 12.

Cover 700 can further comprise a series of longitudinally and sequentially spaced grooves 24 which are formed in interior surface 20, proximate cable end 14, and extend over a predetermined distance. Notably, grooves 24 are not threads as they are not a continuous helix, but rather spaced apart, parallel grooves that function as small reservoirs for any moisture that may infiltrate the open cable end 14 of cover 700. In the field, scratches or other material removal occurs in the jacket of a cable, and moisture may sometimes infiltrate through those scratches and into the seal. Grooves 24 (and the grooves in the other disclosed embodiments) are intended to minimize the effects of any such moisture migration.

Cover 700 can further comprise a plurality of longitudinally spaced strain relief grooves 228 that are formed in exterior surface 18, proximate cable end 14, and extend over a predetermined distance. Each groove 228 extends less than entirely around the circumference of exterior surface 18, although it should be noted that a single strain relief may be suitable in a particular application and the groove could extend entirely around the circumference. In one embodiment, two of the grooves are disconnected from one another by a gap between their ends, and are formed around the circumference of exterior surface in a common plane that extends transverse to a longitudinal axis of the cable end of cover 700. In one embodiment, the strain relief grooves are formed in co-planar pairs around exterior surface 18 and with each pairing extending in laterally spaced, parallel planes to one another.

Cover 700 can also comprise a series of grooves 230 formed entirely circumferentially around exterior surface 18 in spaced, parallel relation to one another. In this embodiment of the present invention, grooves 230 provide reservoirs in which liquid may collect. In one embodiment, grooves 230 provide pressure points to engage or otherwise frictionally interact with grooves on the inner surface of another cover.

FIG. 27 depicts another embodiment of cover 700 adapted to be placed in secure and sealing relation over a connector. In this embodiment, cover 700 (hereinafter designated cover 700′ to differentiate it from the previous embodiment) comprises: an elongated body composed of a flexible material that exhibits a low modulus of elasticity over an extended temperature range, preferably a rubber material, a cable end 14, connector end 16, exterior surface 18, and an interior surface 20.

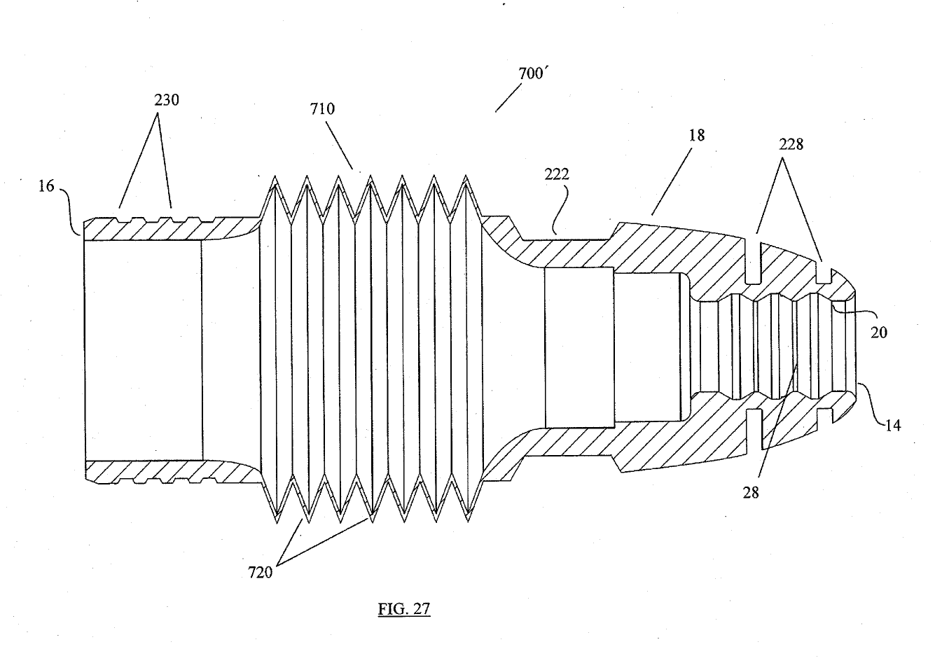

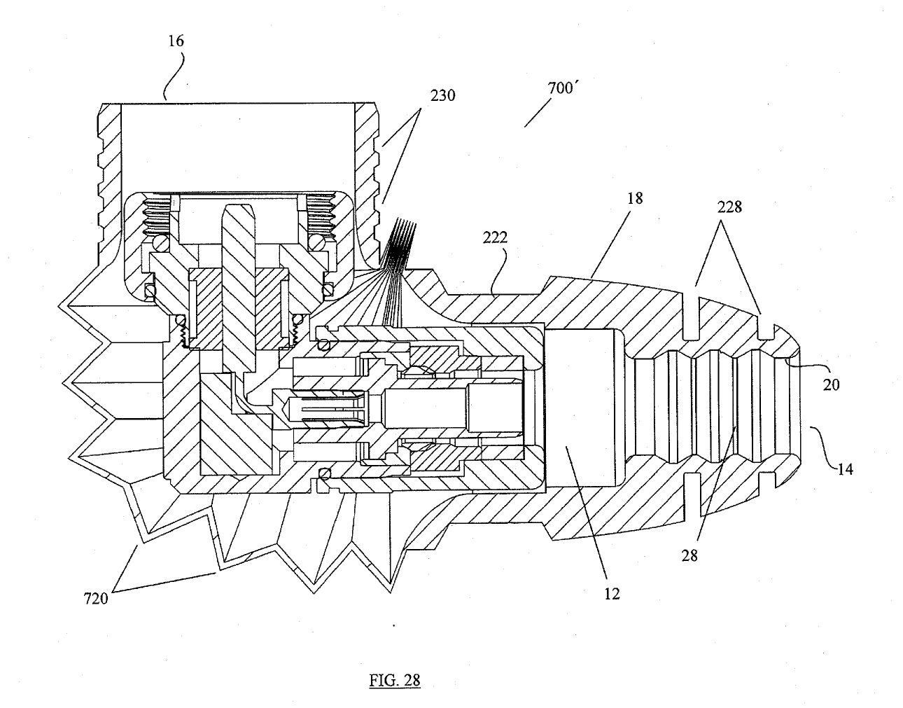

Unlike previous embodiments in which the cover extends along a longitudinal axis after installation (see, for example, the longitudinal X-X axis in FIG. 1), cover 700′ is designed to cover an angled connector, such as the angled connector 12 shown in FIG. 28. Cover 700′ includes a flexible region denoted generally as region 710. Region 710 region comprises a series of circumferential accordion-like folds 720 that, prior to installation over a connector, are transverse to the longitudinal X-X axis and provide maximum flexibility to the cover. Each of folds 720 can be compressed inward such that the body of the cover decreases in length, or can be expanded outward such that the body of the cover increases in length. Additionally, each of the circumferential accordion-like folds can be manipulated by the user/installer such that one region of a single fold is compressed while another region of the same fold is expanded. To further facilitate the increased flexibility, the thickness of the walls of cover 700′ at region 710 can be reduced compared to other regions of the cover.

Due to the flexibility of region 710, the cover is capable of bending in a number of different directions, with each of the accordion-like folds expanding and/or compressing depending on the particular angle of the connector. FIG. 28, for example, shows cover 700′ after installation over a connector 12. Although FIG. 28 depicts cover 700′ adapted to cover a connector with a specific predetermined angle, it should be noted that cover 700′ can be designed to be sufficiently flexible to cover a connector or other component having any specific predetermined angle.

Similar to the previous embodiment, cover 700′ can further comprise an annular groove 222 of reduced diameter (when compared to the other outer regions of the cover) formed at a medial position in exterior surface 18. The reduced diameter of medial section 222 provides a suitable gripping area for a gripping tool or fingers when installing the cover on a connecter or other component.

Cover 700′ can further comprise a series of longitudinally and sequentially spaced grooves 24 which are formed in interior surface 20, proximate cable end 14, and extend over a predetermined distance. Notably, grooves 24 are not threads as they are not a continuous helix, but rather spaced apart, parallel grooves that function as small reservoirs for any moisture that may infiltrate the open cable end 14 of cover 700′. In the field, scratches or other material removal occurs in the jacket of a cable, and moisture may sometimes infiltrate through those scratches and into the seal. Grooves 24 (and the grooves in the other disclosed embodiments) are intended to minimize the effects of any such moisture migration.

Cover 700′ can further comprise a plurality of longitudinally spaced strain relief grooves 228 that are formed in exterior surface 18, proximate cable end 14, and extend over a predetermined distance. Each groove 228 extends less than entirely around the circumference of exterior surface 18, although it should be noted that a single strain relief may be suitable in a particular application and the groove could extend entirely around the circumference. In one embodiment, two of the grooves are disconnected from one another by a gap between their ends, and are formed around the circumference of exterior surface in a common plane that extends transverse to a longitudinal axis of the cable end of cover 700′. In one embodiment, the strain relief grooves are formed in co-planar pairs around exterior surface 18 and with each pairing extending in laterally spaced, parallel planes to one another.

Cover 700′ can also comprise a series of grooves 230 formed entirely circumferentially around exterior surface 18 in spaced, parallel relation to one another. In this embodiment of the present invention, grooves 230 provide reservoirs in which liquid may collect. In one embodiment, grooves 230 provide pressure points to engage or otherwise frictionally interact with grooves on the inner surface of another cover.

Although not shown, angled covers 700 and 700′ can also be employed in a multi-cover system. According to this system the angled cover and a second cover, which is, for example, one of the embodiments described herein or another cable cover known in the art, both splice cables which terminate at a connector. The angled cover slides over and covers at least a portion of the second cover (or vice versa). In addition to forming a protective seal, the interference fit between the interior surface of the outer cover and the grooves on the exterior surface of the inner cover inhibits removal of either cover without the application of force specifically directed toward disassembling the assembly. Furthermore, having the plurality of grooves in the exterior provides redundancy in terms of inhibiting moisture migration; if one of the peaks forming grooves is sliced or otherwise compromised, moisture may infiltrate and reside in the valley of that groove (i.e., each valley provides a successive reservoir for moisture containment).

FIG. 29 depicts another embodiment of a cover system 64. In FIG. 29, system 64 uses cover 800 which is adapted to envelop a connector that terminates in a bulkhead 104. The structure of cover 800 can be the same as or similar to any of the cover embodiments described above. While the structure of cover 800 may be the same as described above, the method of use and resultant arrangement is different.

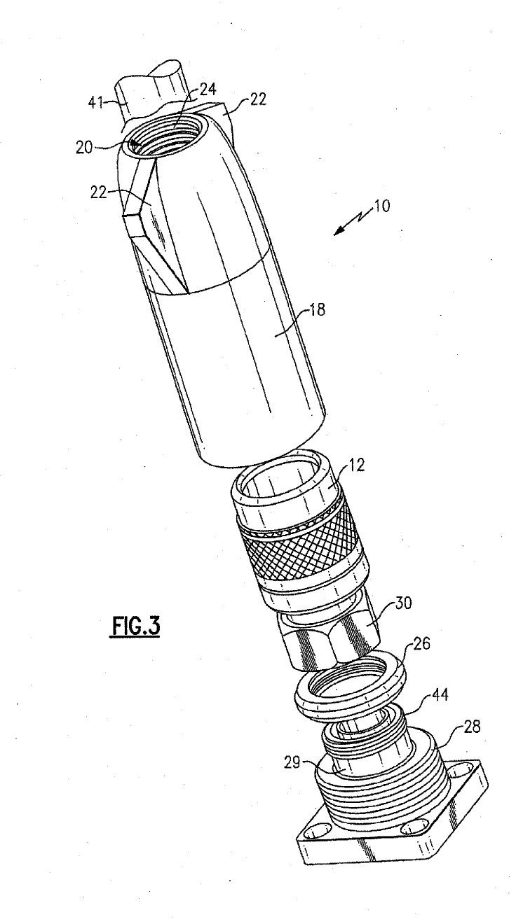

In addition to cover 800, system 64 in FIG. 29 further comprises a customizable port seal 810 with an elongated body which has a cable end 820 and a connector or bulkhead end 830 (shown, for example, in FIG. 30). The port seal is designed to cover a port or connector (shown, for example, in FIGS. 1-7) that extends from bulkhead 104. Similar to the covers, port seal 810 protects the underlying hardware from exposure to moisture and other environmental factors. Since ports and connectors can vary in length, it is desirable to have a versatile port seal system which can adapt to various port sizes. Thus, connector or bulkhead end 830 of port seal 810 can be customized to the desired length and then installed onto the port to form a waterproof seal. Removal can be accomplished by a variety of means, including, for example, cutting the port seal to the desired length.

Thus, the customizable port seal comprises an elongated body that has an initial starting length, and a section near the connector end (see, for example, region 890 in FIG. 29) that is designed to be customizable. At least a portion of section 890 is removable such that the port seal has a post-customization length short than the initial starting length (see, for example, the before and after customization depicted in FIG. 30).

Customizable port seal 810 can be adapted to different lengths prior to being slid onto the hardware component, or, when used in a system similar to system 64 in FIG. 29, the port seal can be adapted to different lengths prior to interacting with cable cover 800.

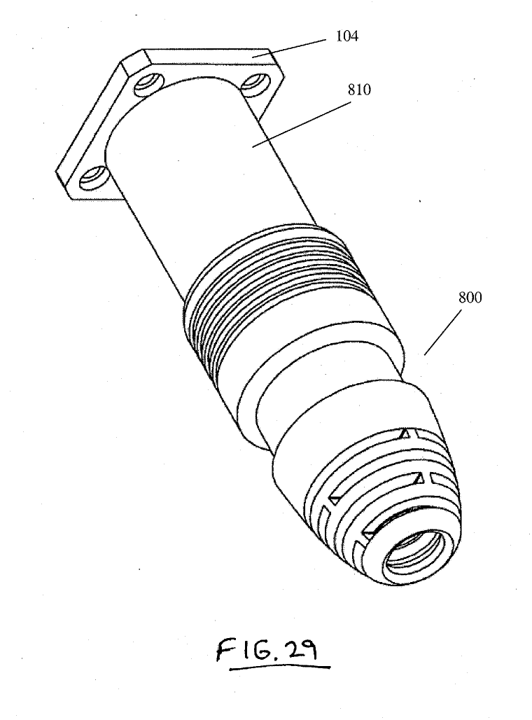

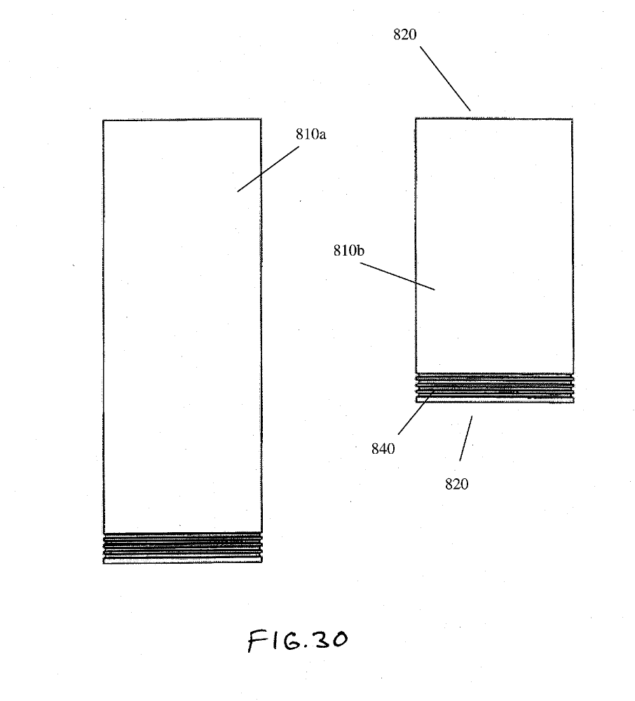

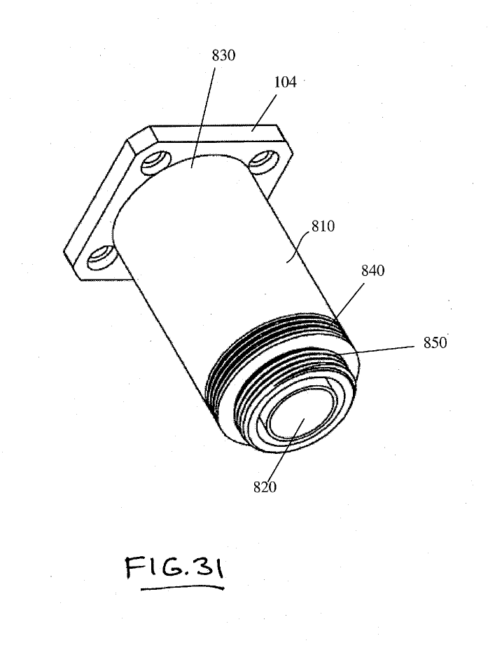

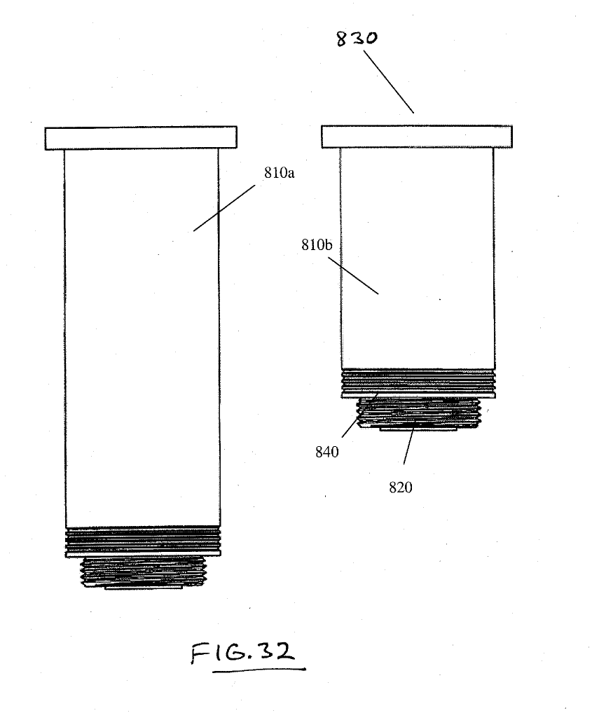

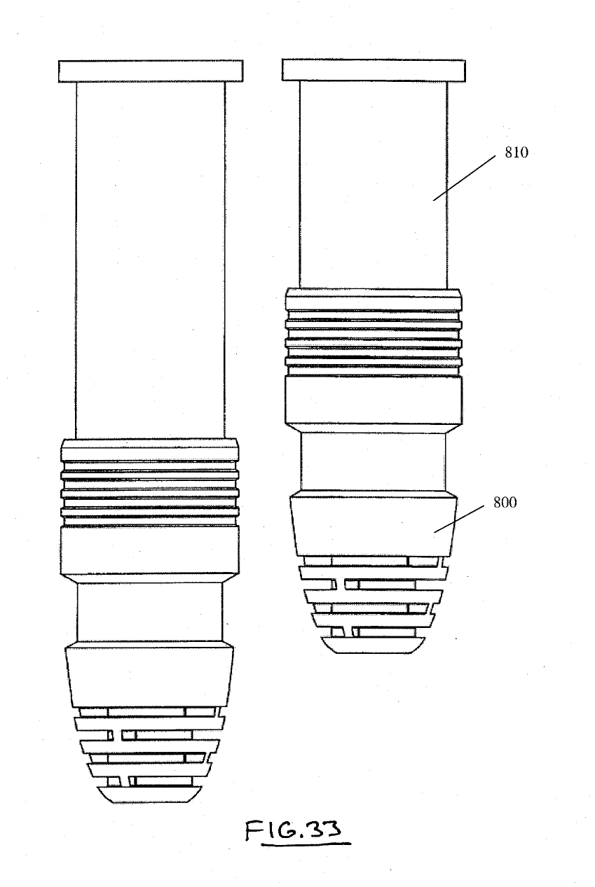

To use cover system 64, port seal 810 is customized to the proper length and slid entirely over the hardware such as a cable connector. Cover 800 is then slid at least partially over the cable end of port seal 810, thereby creating a seal and moisture barrier between the interior surface of the connector end of cover 800 and the exterior surface of the cable end of the port seal. Cable end 820 of port seal 810 in FIG. 30, for example, comprises a series of longitudinally and sequentially spaced grooves 840 which extend over a predetermined distance. Notably, grooves 840 are not threads as they are not a continuous helix, but rather spaced apart, parallel grooves that function as small reservoirs for any moisture that may infiltrate the open cable end 820 of the port seal. In the field, scratches or other material removal occurs in the jacket of a cable, and moisture may sometimes infiltrate through those scratches and into the seal. Grooves 840 (and the grooves in the other disclosed embodiments) are intended to minimize the effects of any such moisture migration. The port seal in FIG. 30 further comprises a secondary ring 850 at the cable end which has a smaller diameter than the larger ring comprising grooves 840. Indeed, the end of the port seal can be designed according to any method or design as is needed or as is known in the art. This embodiment of the customizable port seal 810 is further depicted in FIG. 31, which shows an example of port seal of adjusted length. Although both port seals may have been produced to be the same length, port seal 810b was adjusted to be a shorter length to cover/seal a shorter connector. In FIG. 33, covers have been placed over the variable-length port seals.

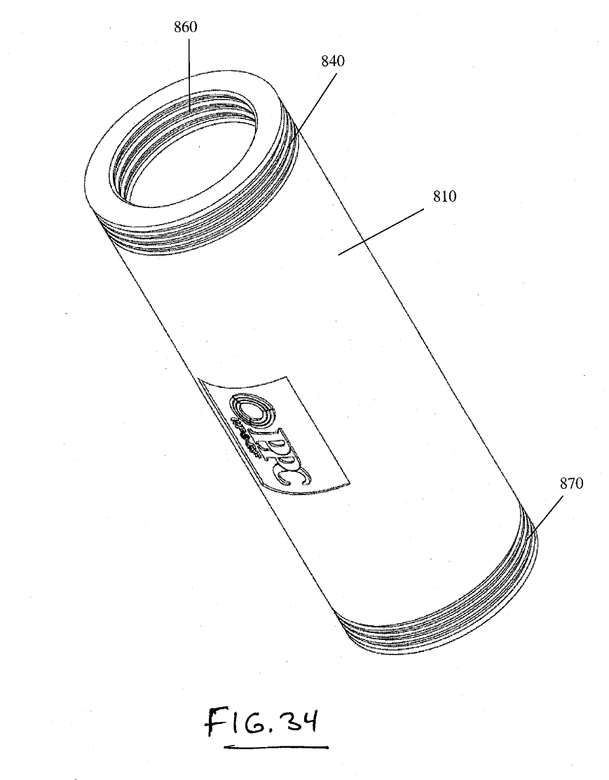

FIGS. 34 and 35 depict another embodiment of port seal 810. Similar to the previous embodiments, the port seal comprises a series of longitudinally and sequentially spaced grooves 840 which extend over a predetermined distance. Notably, grooves 840 are not threads as they are not a continuous helix, but rather spaced apart, parallel grooves that function as small reservoirs for any moisture that may infiltrate the open cable end 820 of the port seal. In the field, scratches or other material removal occurs in the jacket of a cable, and moisture may sometimes infiltrate through those scratches and into the seal. Grooves 840 (and the grooves in the other disclosed embodiments) are intended to minimize the effects of any such moisture migration. In this embodiment, the port seal comprises a second set of exterior grooves 870 on the opposite end of the seal. The port seal in FIGS. 34 and 35 also comprises an additional set of grooves 860 on the interior surface of one or both ends of the port seal. These additional grooves create an additional environmental barrier.

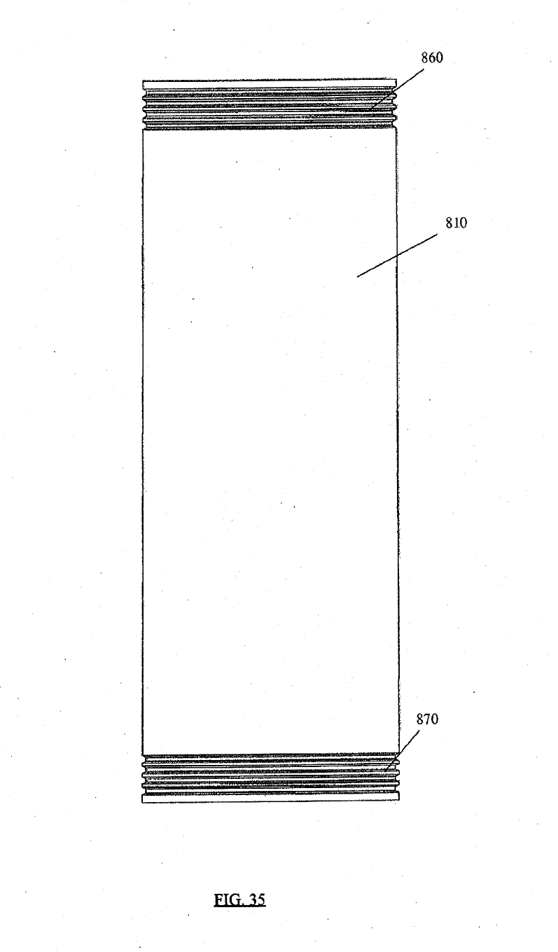

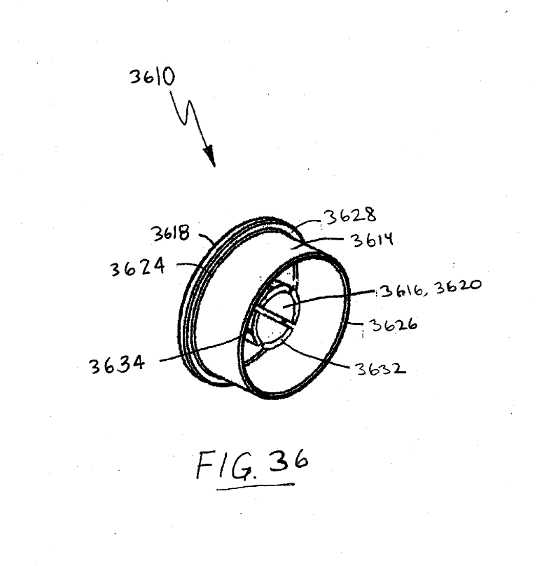

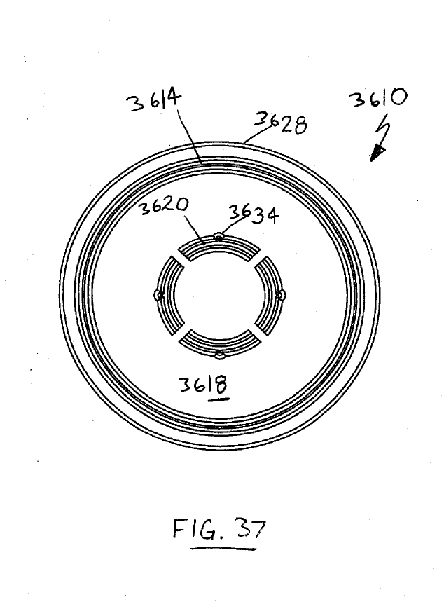

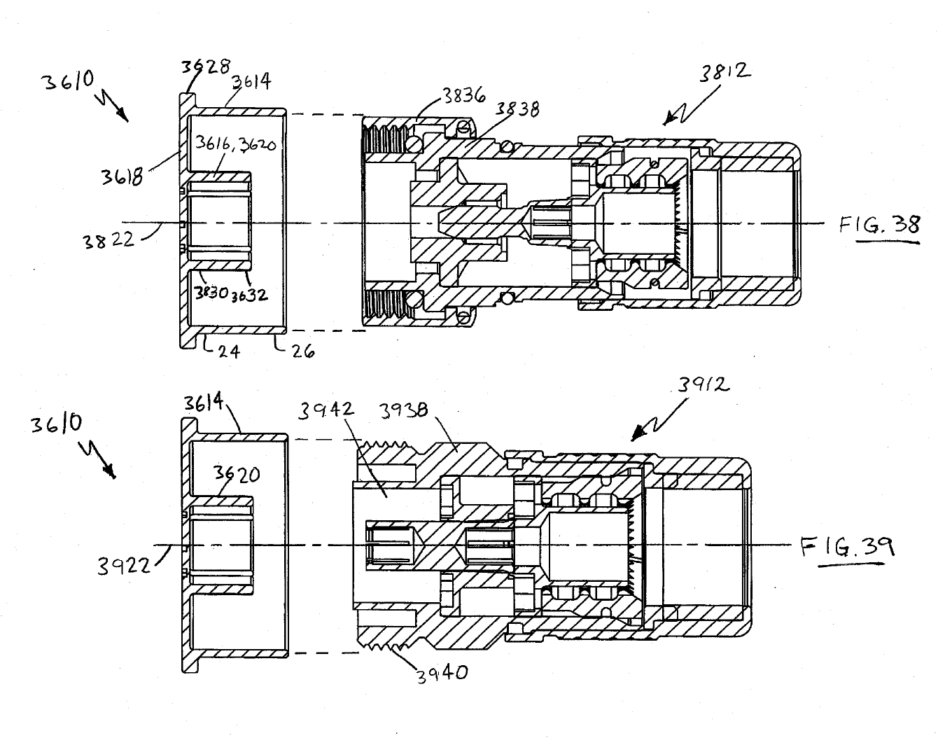

FIG. 36 depicts a side perspective view of a protective connector cap, or coaxial cable connector interface cover, 3610. In the illustrated embodiment, the protective connector cap 3610 is adapted for use with a DIN-type connector. FIG. 38 depicts an exploded cross-sectional view of the protective connector cap 3610 and a male DIN-type connector 3812. FIG. 39 depicts an exploded cross-sectional view of the protective connector cap 3610 and a female DIN-type connector 3812. FIG. 40 depicts a cross-sectional view of the protective connector cap 3610 engaged with the male DIN-type connector 3812, and FIG. 41 depicts a cross-sectional view of the protective connector cap 3610 engaged with the female DIN-type connector 3912.

Referring to FIGS. 36-41, the protective connector cap 3610 includes an outer sleeve 3614, an inner sleeve 3616, and a cover 3618. The inner sleeve 3616 does not have to be formed of a solid cylinder. In the disclosed embodiment, the inner sleeve 3616 is sectioned to include a plurality of inner fingers 3620 oriented along the longitudinal axis 3822. The cover, or lid, 3618 has a diameter and/or surface area large enough to cover the end of the connector with which the interface cover 3610 is used. The outer sleeve 3614 extends generally perpendicularly from the cover 3618, as a cylinder to overlay the cylindrical shape of the connector with which the protective connector cap 3610 is used. The end of the outer sleeve 3614 where the outer sleeve intersects and joins the cover 3618 defines a base end 3624 of the outer sleeve, and the opposing end defines a tip end 3626 of the outer sleeve 3614. The outer sleeve 3614 can be shaped otherwise to match connectors having other shapes. The lid 3618 can have a lip 3628 that extends from the lid 3618 beyond the diameter of the lid 3618 where the outer sleeve 3614 intersects and joins the lid 3618.

The inner fingers 3620 can be circumferentially spaced, arranged concentrically within and spaced apart from the outer sleeve 3614. The inner fingers 3620 can extend from the cover 3618, with a base end 3830 of each inner finger 3620 being at the end of each inner finger 3620 intersecting and joining the cover 3618, and the opposing end of each inner finger 3620 being a tip end 3632 of each inner finger 3620. Each inner finger 3620 can have a rib 3634 that extends from the base end 3830 of the respective inner finger 3620 to the tip end 3632 of the respective inner finger 3620. Each rib 3634 can extend along the center of the respective inner finger 3620, from the base end 3830 of the respective inner finger 3620 toward the tip end 3632 of the respective inner finger 3620, either a partial length of the inner finger 3620, or the entire length of the inner finger 3620. Each rib 3634 can project radially outward from the radially outward facing surface of the respective inner finger 3620, and each rib 3634 can be rounded on the radially outward facing surface of each rib 3634.

Four inner fingers 3620 are depicted in the illustration. However, there can be a greater or lesser number of inner fingers 3620. A greater number of smaller inner fingers 3620 can provide more flexibility to, for example, accommodate larger connector manufacturing tolerances or size variations; and a lesser number of larger inner fingers 3620 can provide more rigidity and tension to hold the protective connector cap 3610 in place on the connector, as will be described more below.

As one example of a protective connector cap 3610 that can be used with a 7/16 inch DIN male connector 3812 and female connector 3912, the inner diameter of the outer sleeve 3614 can be approximately 1.375 inches (3.50 cm), with a thickness of the outer sleeve 3614 being approximately 0.050 inches (0.127 cm). The inner diameter of the inner fingers 3620 can be approximately 0.520 inches (1.321 cm), with a thickness of the inner fingers 3620 being approximately 0.050 inches. The length from the inside of the cover 3618 to the tip end 3626 of the outer sleeve 3614 can be approximately 0.625 inches (1.60 cm), with the lid being approximately, 0.050 inches thick (0.127 cm). The length from the inside of the cover 3618 to the tip end 3632 of each inner finger 3620 can be approximately 0.40 inches (1.016 cm). The thicknesses can be altered to achieve more or less flexibility and/or strength, while the diameters and lengths can be adjusted to accommodate connectors of other sizes and types.

FIG. 40 depicts a cross-sectional view of the protective connector cap 3610 engaged with the male DIN-type connector 3812. The male DIN-type connector 3812 has a longitudinal axis 3822, an interface nut 3836 and an interface body 3838. The protective connector cap 3610 is assembled onto the connector 3812 by aligning the protective connector cap 3610 with the longitudinal axis 3822 of the DIN connector 3812 and moving the protective connector cap 3610 axially toward and onto the DIN connector 383812. The outer sleeve 3614 slides over the interface nut 3836 with an interference fit that creates sliding friction between the protective connector cap 3610 and the interface nut 3836. The inner fingers 3620 slide within the interface body 3838, with an interference fit that creates a sliding friction between the protective connector cap 3610 and the interface body 3838. The inner finger ribs 3634 can alternatively make contact with the interface nut 3836, focusing the pressure and friction on the ribs 3634. The inner fingers 3620 and the outer sleeve 3614 can flex and/or resiliently stretch without deforming to fit while maintaining enough friction to retain the protective connector cap 3610 on the DIN connector 3812.

FIG. 41 depicts a cross-sectional view of the protective connector cap 3610 of FIG. 36 engaged with a female DIN-type connector 3912. Referring to FIG. 41, the female DIN connector 3912 has a longitudinal axis 3922 and an interface body 3938. The interface body 3938 has external threads 3940 and an inner portion 3942. The protective connector cap 3610 is assembled onto the DIN connector 393812 by aligning the protective connector cap 3610 with the longitudinal axis 3822 of the DIN connector 3912 and moving the protective connector cap 3610 axially toward and onto the DIN connector 3912. The outer sleeve 3614 slides over the external threads 3940. There can be an interference fit that creates sliding friction between the protective connector cap 3610 and the interface body 3938, and that helps provide force to retain the protective connector cap 3610 on the DIN connector 3912. The inner fingers 3620 slide within the inner portion 3942 of the interface body 3938, with an interference fit that creates a sliding friction between the protective connector cap 3610 and the inner portion 3942 of the interface body 3938. The ribs 3634 can alternatively make contact with the inner portion 3942 of the interface body 3938, focusing the pressure and friction on the ribs 3634. The inner fingers 3620 and the outer sleeve 3614 can flex and/or resiliently stretch without deforming to fit while maintaining enough friction to retain the protective connector cap 3610 on the DIN connector 393812. Each protective connector cap 3610 can be functional with the male and female version of at least one size of the DIN connectors 3812, 3912.

The protective connector cap 3610 can be made of polyethylene, another type of plastic, or another similar material that is flexible yet durable.

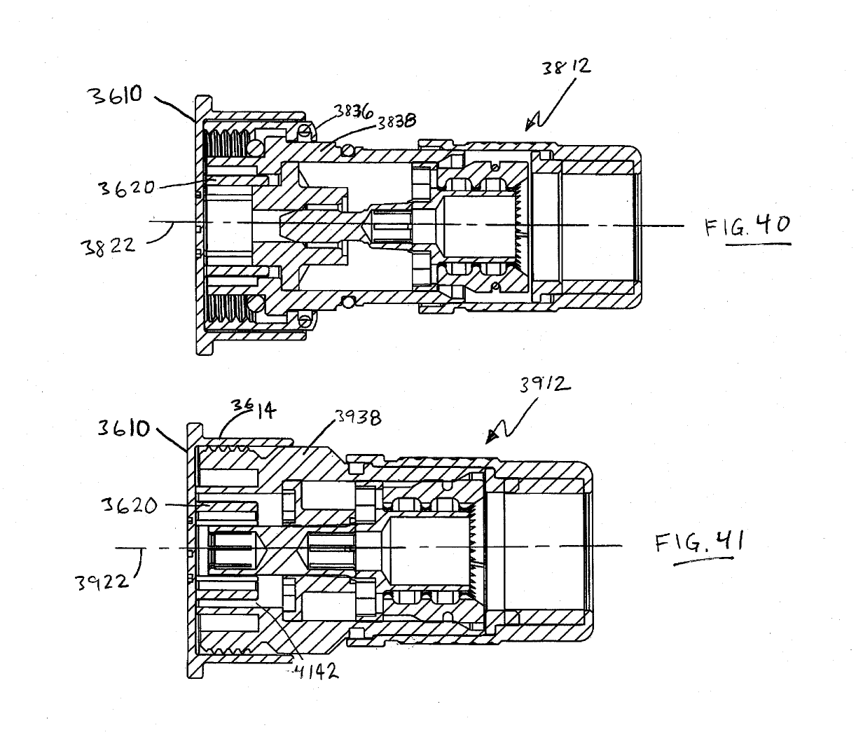

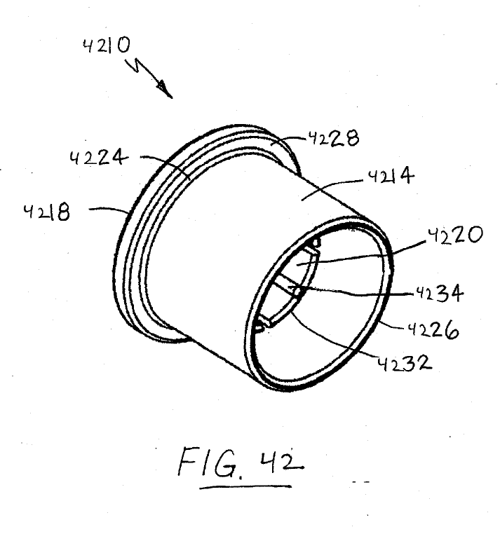

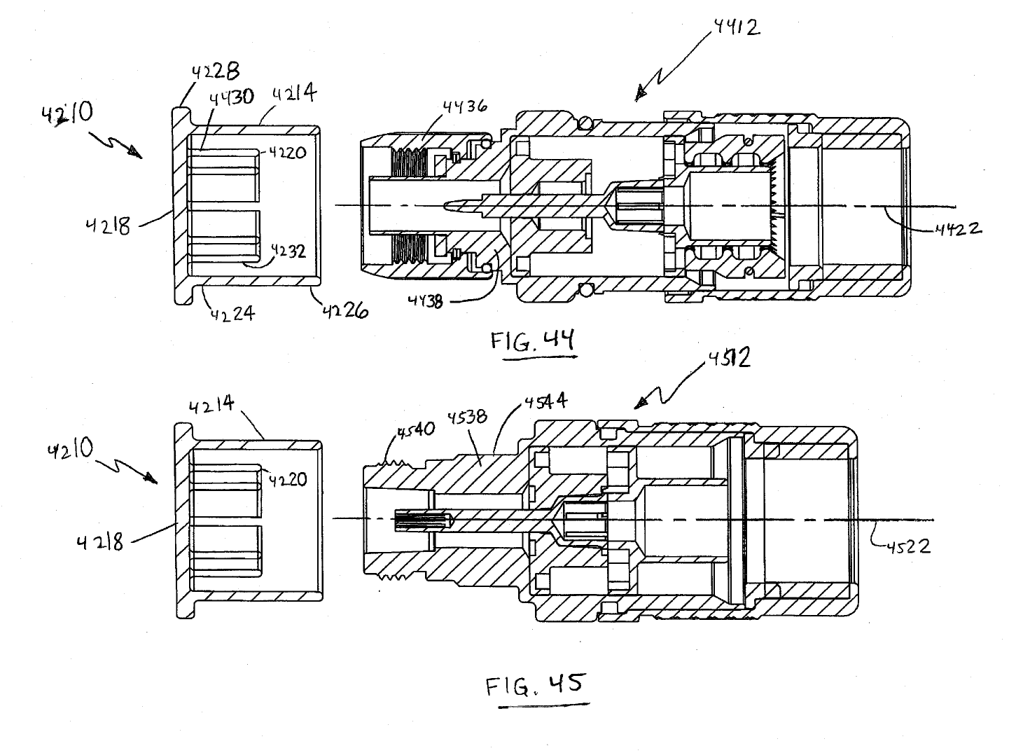

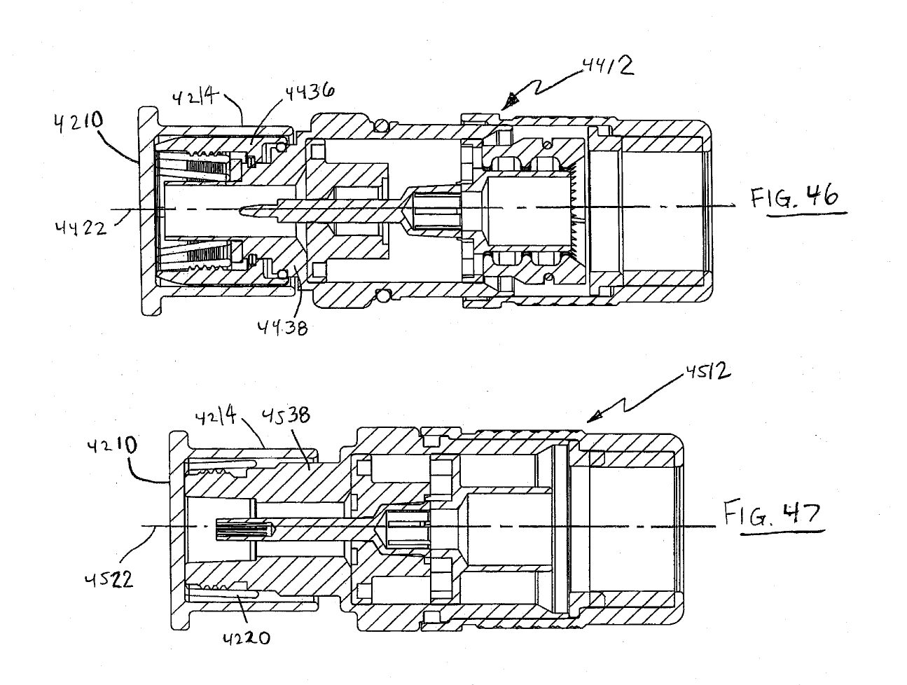

FIG. 42 depicts a side perspective view of a protective connector cap 4210 for an N-type connector, according to another embodiment of the invention. FIG. 44 depicts an exploded cross-sectional view of the protective connector cap 4210 and a male N-type connector 4412. FIG. 45 depicts an exploded cross-sectional view of the protective connector cap 4210 and a female N-type connector 4512. FIG. 46 depicts a cross-sectional view of the protective connector cap 4210 engaged with the male N-type connector 4412, and FIG. 47 depicts a cross-sectional view of the protective connector cap 4210 engaged with the female N-type connector 4512.

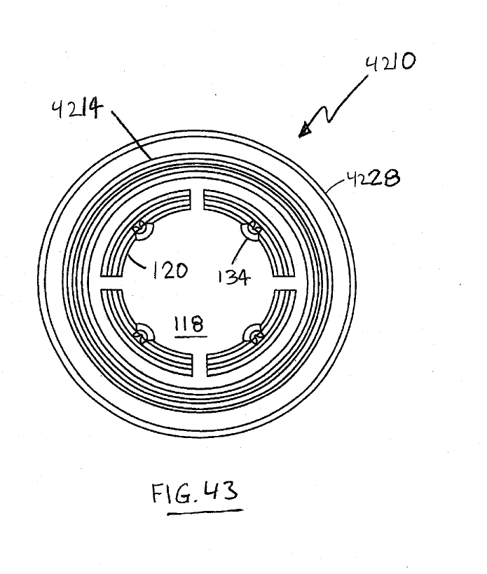

Referring to FIGS. 42-47, the protective connector cap 4210 comprises an outer sleeve 4214, inner fingers 4220, and a lid 4218, similar to those of the embodiment illustrated in FIGS. 36-41. The lid 4218 has a diameter and/or surface area large enough to cover the end of the connector with which the protective connector cap 4210 is used. The outer sleeve 4214 extends generally perpendicularly from the lid 4218, as a cylinder to overlay the cylindrical shape of the connector with which the protective connector cap 4210 is used. The end of the outer sleeve 4214 where the outer sleeve 4214 intersects and joins the lid 4218 comprises a base end 4224 of the outer sleeve, and the opposing end is a tip end 4226 of the outer sleeve 4214. The outer sleeve 4214 can be shaped otherwise to match connectors having other shapes. The lid 4218 can have a lip 4228 that extends from the lid 4218 beyond the diameter of the lid 4218 where the outer sleeve 4214 intersects and joins the lid 4218.

The inner fingers 4220 can be circumferentially spaced, arranged concentrically within and spaced apart from the outer sleeve 4214. The inner fingers 423620 can extend from the lid 4218, with a base end 4430 of each inner finger 4220 being at the end of each inner finger 4220 intersecting and joining the lid 4218, and the opposing end of each inner finger 4220 being a tip end 4232 of each inner finger 4220.

As with the embodiment illustrated in FIGS. 36-41, four inner fingers 4220 are depicted in FIGS. 40 and 41. However, there can be a greater or lesser number of inner fingers 4220. A greater number of smaller inner fingers 4220 can provide more flexibility to, for example, accommodate larger connector manufacturing tolerances or size variations; and a lesser number of larger inner fingers 4220 can provide more rigidity and tension to hold the protective connector cap 4210 in place on the connector, as will be described more below.

A rib 4234 can also extend along the center of each inner finger 4220, and can extend from the base end 4430 of the respective inner finger 4220 toward the tip end 4232 of the respective inner finger 4220, either a partial length of the inner finger 4220, or the entire length of the inner finger 4220. However, the ribs 4234 can be on the inwardly facing surface of the inner fingers 4220 rather than the outwardly facing surface of the inner fingers 4220, and each rib 4234 can be rounded on the radially inward facing surface of each rib 4234.

Also, the length the outer sleeve 4214 extends from the lid 4218 is different from the embodiment illustrated in FIGS. 36-41. The spacing between the inner fingers 4220 and the outer sleeve 4214 is also different from the embodiment illustrated in FIGS. 36-41 in order to accommodate the male and female versions of the N-type connector (connectors 4412, 4512, respectively) rather than the male and female versions of the DIN-type connector (connectors 3812, 3912, respectively). Appropriate similar modifications can be made to accommodate other types and/or sizes of connectors so that one protective connector cap can fit the male and female versions of those other types and/or sizes of connectors.

The difference in rib location and the dimensional differences are guided by the different types and/or sizes of connectors. However, each protective connector cap 3610, 4210 can be functional with a single type and size of connector, regardless whether that single type and size of connector is male or female. In other words, each protective connector cap 3610, 4210 can be functional with the male and the female version of at least one type and size of connector.

As one example of a protective connector cap 4210 that can be used with a 7/16 inch N-type male connector 4412 and female connector 4512, the inner diameter of the outer sleeve 4214 can be approximately 0.80 inches, with a thickness of the outer sleeve 4214 being approximately 0.050 inches (0.127 cm). The inner diameter of the inner fingers 4220 can be approximately 0.560 inches (1.422 cm), with a thickness of the inner fingers 4220 being approximately 0.375 inches (0.952 cm). The length from the inside of the lid 4218 to the tip end 4226 of the outer sleeve 4214 can be approximately 0.721 inches (1.831 cm), with the lid being approximately, 0.079 inches thick (0.200 cm). The length from the inside of the cover 4218 to the tip end 4232 of each inner finger 4220 can be approximately 0.391 inches (0.993 cm). The thicknesses can be altered to achieve more or less flexibility and/or strength, while the diameters and lengths can be adjusted to accommodate connectors of other sizes and types, and to adjust the fit of the protective connector cap 4210.

FIG. 46 depicts a cross-sectional view of the protective connector cap 4210 of FIG. 42 engaged with a male N-type connector. Referring to FIG. 46, the male N-type connector 4412 has a longitudinal axis 4422, an interface nut 4436 and an interface body 4438. The protective connector cap 4210 is assembled onto the connector 4412 by aligning the protective connector cap 4210 with the longitudinal axis 4422 of the N-type connector 4412, and moving the protective connector cap 4210 axially toward and onto the connector 4412. The outer sleeve 4214 slides over the interface nut 4436 with an interference fit that creates sliding friction between the protective connector cap 4210 and the interface nut 4436. The inner fingers 4220 slide within the interface nut 4436, with an interference fit that creates a sliding friction between the protective connector cap 4210 and the interface nut 4436. The inner fingers 4220 and the outer sleeve 4214 can flex and/or resiliently stretch without deforming to fit while maintaining enough friction to retain the protective connector cap 4210 on the N-type connector 4412.

FIG. 47 depicts a cross-sectional view of the protective connector cap 4210 of FIG. 42 engaged with a female N-type connector 4512. Referring to FIG. 47, the female N-type connector 4512 has a longitudinal axis 4522 and an interface body 4538. The interface body 4538 has external threads 4540. The protective connector cap 4210 is assembled onto the N-type connector 4512 by aligning the protective connector cap 4210 with the longitudinal axis 4522 of the N-type connector 4512, and moving the protective connector cap 4210 axially toward and onto the connector 4512. In one embodiment, the outer sleeve 4214 engages an outer diameter 4544 of the interface body 4538. There can be an interference fit that creates sliding friction between the outer sleeve 4214 of the protective connector cap 4210 and outer diameter 4544 the interface body 4538, and that helps provide force to retain the protective connector cap 4210 on the N-type connector 4512.

In another embodiment, the inner fingers 4220 slide over the external threads 4540. There can be an interference fit that creates sliding friction between the inner fingers 4220 of the protective connector cap 4210 and the interface body 4538, and that helps provide force to retain the protective connector cap 4210 on the N-type connector 4512. The inner finger ribs 4234 ribs can alternatively make contact with the interface body 4538, focusing the pressure and friction on the ribs 4234. The inner fingers 4220 and the outer sleeve 4214 can flex and/or resiliently stretch without deforming to fit while maintaining enough friction to retain the protective connector cap 4210 on the N-type connector 4512. Each protective connector cap 4210 can be functional with the male and female version of at least one size of the N-type connectors 4512.

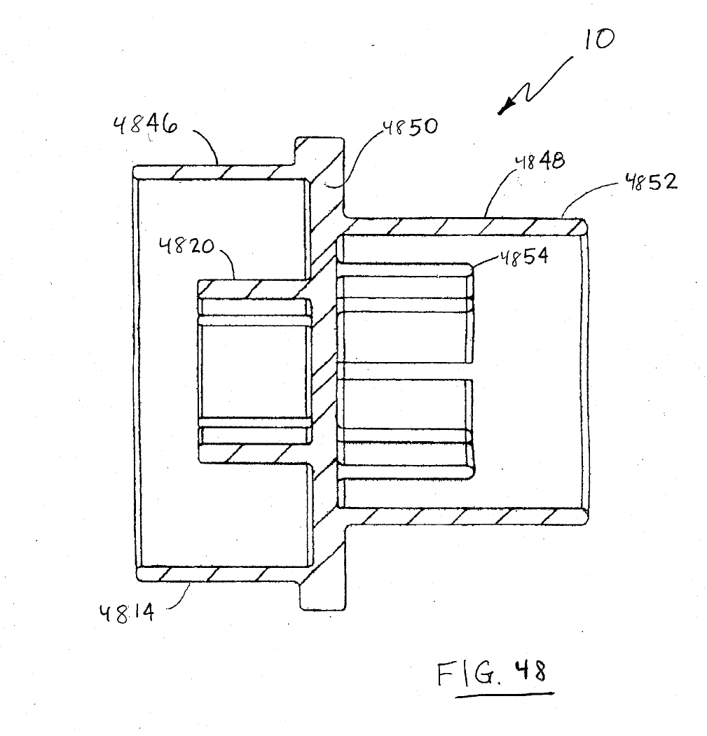

FIG. 48 depicts a cross-sectional side view of a protective connector cap 4810 according to yet another embodiment of the invention. Referring to FIG. 48, a first portion 4846 of the cap 4810 protects a DIN-type connector, such as connectors 3812, 3912. A second portion 4848 of the cap 4810 protects an N-type connector, such as connectors 4412, 4512. The first portion 4846 and the second portion 4848 are joined by a common back plate 4850, which was the lid in previous embodiments. As disclosed with reference to the protective connector cap 4810 for the DIN-type connector, the first portion 484846 includes an outer sleeve 4814 and an inner sleeve 4816 which, in the disclosed embodiment, is sectioned to include a plurality of inner fingers 4820 oriented along a longitudinal axis 4822. The outer sleeve 4814 and the inner fingers 4820 are dimensioned in accordance with the protective connector cap 4810 for the DIN-type connector disclosed hereinabove. The inner fingers 4820 may include inner finger ribs (not shown).

As disclosed with reference to the protective connector cap 4810 for the N-type connector, the second portion 4848 includes a second outer sleeve 4852 and a second inner sleeve 4854, which, in the disclosed embodiment, is sectioned to include a plurality of second inner fingers 4854. The second outer sleeve 4852 and the second inner fingers 4854 are dimensioned in accordance with the protective connector cap 4210 for the N-type connector disclosed hereinabove. The second inner fingers 4854 may include second inner finger ribs (not shown).

One advantage of the protective connector cap 4810 is that a single one of these alternative protective connector caps 4810 can fit and be used to protect the male and female version of the DIN-type connectors 3612, 3912 and the N-type connectors 4412, 4512. Using a single protective connector cap 4810 can further reduce manufacturing and inventory costs, by further decreasing the number of types of protective connector caps used and stored in inventory, and by decreasing the number of different protective connector caps that require different manufacturing systems. Other variations of the protective connector caps can be combined similarly in order to provide protective connector caps that fit other combinations of connectors.

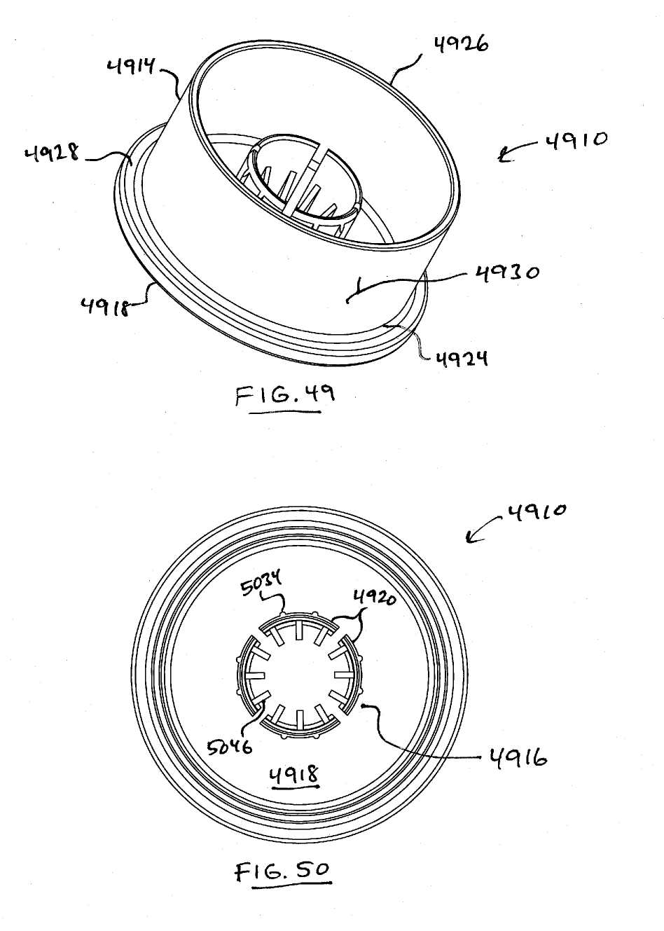

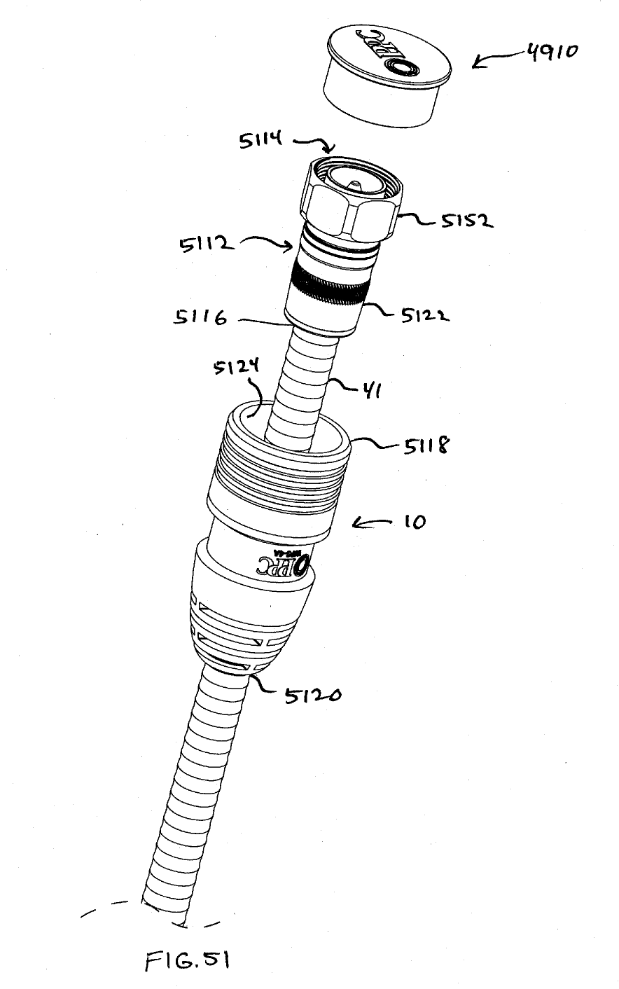

FIG. 49 depicts a side perspective view of a coaxial cable connector interface cover 4910. In the illustrated embodiment, the interface cover 4910 is adapted for use with a DIN-type connector. FIG. 50 is a bottom plan view of the interface cover 4910. In this view, the inner ribs 5046 and outer ribs 5034 are best viewed.

The coaxial cable connector interface cover 4910 includes an outer sleeve 4914, an inner sleeve 4916, and a lid, or cover, 4918. The outer sleeve 4914 extends perpendicularly from the lid 4918, as a cylinder to overlay the cylindrical shape of the connector with which the interface cover 4910 is used. The end of the outer sleeve 4914 where the outer sleeve intersects and joins the lid 4918 defines a base end 4924 of the outer sleeve 4914, and the opposing end defines a tip end 4926 of the outer sleeve 4914. The outer sleeve 4914 can be shaped otherwise to match connectors having other shapes. The inner sleeve 4916 does not have to be solid, but it may be made up of a number of sleeve sections, or fingers. In the disclosed embodiment, the inner sleeve 4916 is sectioned to include a plurality of inner fingers 4920 centrally located and extending from the lid 4918. The lid 4918 has a diameter and/or surface area large enough to cover the end of the connector with which the interface cover 4910 is used. The lid 4918 can have a lip 4928 that extends from the lid 4918 beyond the diameter of the lid 4918 where the outer sleeve 4914 intersects and joins the lid 4918.

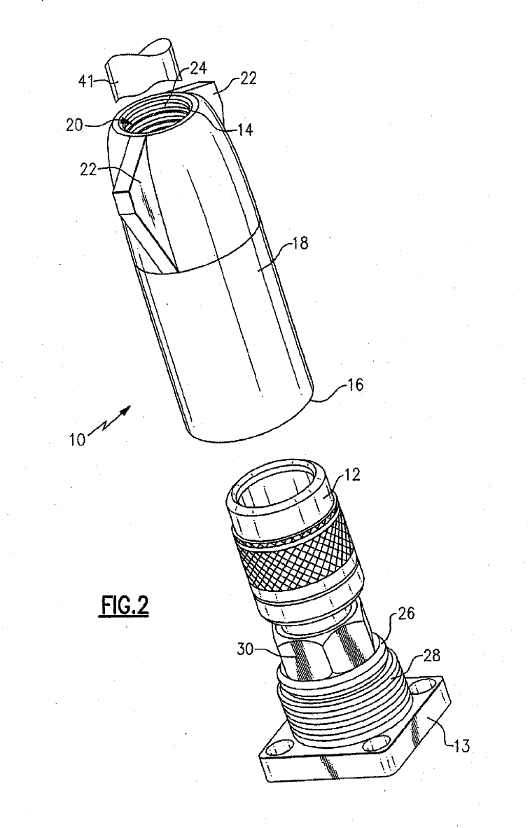

The interface cover 4910 is similar to the interface cover 10 shown in FIGS. 1 and 2. The description of elements in those figures will apply equally to those elements in FIGS. 49-50. The interface cover 4910 presents one new element, the inner rib 5046, best shown in FIG. 50. The inner rib 5046 extends radially inward from the inner sleeve 4916. The inner rib 5046 adapts to the central contact of the DIN female connector 3912. One of more ribs 5046 may be present. In the illustrated embodiment, there are twelve ribs 5046. In FIG. 50 the outer rib 5034 layout is illustrated as two ribs 5034 for each inner finger 4920. The outer rib 3634 in FIG. 37 is shown as one outer rib 3634 for each inner finger 3620. The outer rib 5034 may vary as described for outer rib 3634.

Now referring to FIGS. 49-52, the outer sleeve 4914 has an outer surface 4930. The outer surface 4930 is the sealing surface that mates with the inner surface 5124 of the internal region, or sealing region, 248 of the weatherproof cover 10. The outer surface 4930 and the inner surface 5124 may include scorelines, waves, serrations, or other surface texture to enhance the resistance of contaminant migration between the two mated surfaces 4930 and 5124. The sealing interface between the two surfaces 4930 and 5124 in the sealing region 248 prevents the ingress of environmental hazards such as moisture and dirt, etc. It should be noted that the outer surface 4930 may surround any number of internal feature that are adapted to receive various connector interfaces, such as the N-male and N-female interfaces. The outer surface 4930 is configured to sealingly fit into the weatherproof cover 10, not necessarily to engage the connector interface, although in the illustrated embodiment, the interface nut 5152 engages the sleeve 4914.

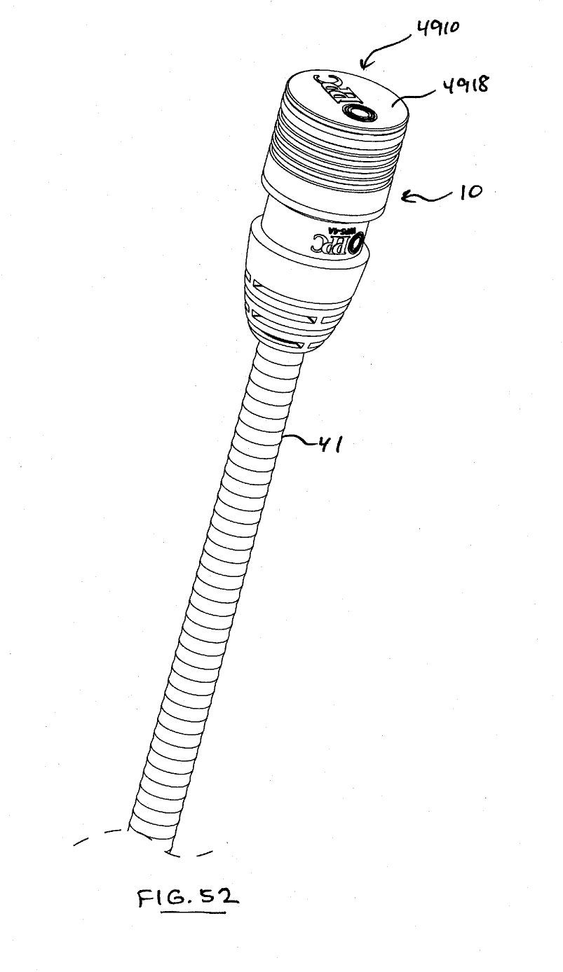

FIG. 51 illustrates a typical installation of the interface cover 4910 to a connector 5112 including a connector body 5122, an interface end 5114 and a connector cable end 5116. The illustrated terminated cable end may be part of a pre-assembled or factory assembled jumper cable. The cable assembly may also represent an on-site construction. There are many instances where a removeable sealing assembly for a coaxial cable end will be useful. In the illustration, the interface end 5114 is a DIN male configuration having an interface nut, or coupling element/nut, 5152. In use, the coaxial cable 41 receives a weatherproof cover 10 with a cover cable end 5120 and a cover interface end 5118. The cover cable end 5120 is adapted to elastically engage the coaxial cable 41. The connector 5112 is assembled to the coaxial cable 41 at the connector cable end 5116 after the weatherproof cover 10 is engaged with the cable 41. The interface cover 4910 is placed over the interface nut 5152 according to the illustration. As stated within this specification, other interface styles and genders may also apply. The weatherproof cover 10 is adapted to slide over the connector 5112 from the installed cable end 5116 toward the interface end 5114 to fully cover the connector 5112 and overlap the sleeve 4914 of the interface cover 4910.

FIG. 52 illustrates the final assembly of the interface cover 4910 and the weatherproof cover 10 onto the terminated end of a coaxial cable 41 with only the lid 4918 of the interface cover 4910 showing. While it has not been explicitly discussed above, FIG. 52 may illustrate equally well the installation of a weatherproof cover 10 and an interface cover 4910 onto terminal end of a coaxial cable 41. Such an arrangement may be useful on-site where coaxial cable may be cut to length a period of time prior to the installation of the coaxial cable connectors. Since the interface cover 4910 is reusable, the interface cove 4910 may be removed from the unterminated cable 41 and the weatherproof cover 10 may be slid away from the end of the cable 41 in order to install a connector 5112. After the connector 5112 is installed, the previously removed interface cover 4910 may be installed onto the connector interface end 5114 and the weatherproof cover 10 may be slid over the connector 5112 and the sleeve 4914 of the interface cover 4910.

In another embodiment, an adaptor, such as adaptor 350 shown in FIGS. 21A-C, may provide the inner sealing surface to be mated with the outer surface 4930 of the interface cover 4910. In this configuration, the adaptor lies between the sealing region of the passageway and the outer surface of the sleeve. That is, the adaptor is in sealing communication with both the passageway and the interface cover.

Although several embodiments of the present invention have been specifically described herein, the full scope and spirit of the present invention is not to be limited thereby, but instead extends to the metes and bounds as defined by the appended claims. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

We claim:

1. A protective connector cap for a connector, comprising:
a lid;
a first outer sleeve extending from the lid;
a plurality of first inner fingers circumferentially spaced, arranged concentrically within the outer sleeve and spaced apart from the outer sleeve;
wherein the spacing between the plurality of inner fingers and the outer sleeve is configured to provide an interference fit between at least one of the outer sleeve and the connector, and the plurality of inner fingers and the connector, with both a male version and a female version of the connector.

2. The protective connector cap of claim 1, further comprising:
a second outer annular wall extending from the cover in a direction opposite the direction the outer sleeve extends from the cover; and
a plurality of second inner fingers circumferentially spaced, arranged concentrically within the second outer sleeve and spaced apart from the first outer sleeve,
wherein the spacing between the second plurality of inner fingers and the first outer sleeve is configured to provide an interference fit between at least one of the first outer sleeve and the connector, and the second plurality of inner fingers and the connector, with both a male and a female version of the connector.

3. The protective connector cap of claim 1, wherein the first outer sleeve extends perpendicularly from the lid.

4. The protective connector cap of claim 1, wherein a rib extends away from the lid along a radially outwardly facing surface of each finger in the plurality of first inner fingers.

5. The protective connector cap of claim 1, wherein a rib extends away from the lid along a radially inwardly facing surface of each finger in the first plurality of inner fingers.

6. The protective connector cap of claim 1, wherein the lid has a greater diameter than the first outer annular wall.

7. The protective connector cap of claim 1, wherein the protective connector cap is comprised of a plastic.

8. The protective connector cap of claim 1, wherein the first plurality of inner fingers is configured to have an interference fit with an interface body of the connector.

9. The protective connector cap of claim 1, wherein the first plurality of inner fingers is configured to have an interference fit with an interface nut of the connector

10. An connector interface cover for a connector adapted to terminate a cable, the connector interface cover comprising:
a lid;
a first outer sleeve extending from the lid; and
a first plurality of inner fingers circumferentially spaced, arranged concentrically within the first outer sleeve.

11. The connector interface cover of claim 10, wherein the first outer sleeve extends perpendicularly from the lid.

12. The connector interface cover of claim 10, wherein the first plurality of inner fingers is spaced apart from the outer wall.

13. The connector interface cover of claim 10, wherein a rib extends away from the lid along a radially outwardly facing surface of each finger in the first plurality of inner fingers.

14. The connector interface cover of claim 10, wherein a rib extends away from the lid along a radially inwardly facing surface of each finger in the first plurality of inner fingers.

15. The connector interface cover of claim 10, wherein the lid has a greater diameter than the first outer annular wall.

16. The connector interface cover of claim 10, wherein the protective connector cap is comprised of a plastic.

17. The connector interface cover of claim 10, wherein the first plurality of inner fingers is configured to have an interference fit with an interface body of the connector.

18. The connector interface cover of claim 10, wherein the first plurality of inner fingers is configured to have an interference fit with an interface nut of the connector.

19. The connector interface cover of claim 10, wherein the first outer sleeve is configured to have an interference fit with an interface body of the connector.

20. The connector interface cover of claim 10 further comprising:
a second outer annular wall extending from the lid in a direction opposite the direction the first outer annular wall extends from the lid; and
a second plurality of inner fingers circumferentially spaced, arranged concentrically within the second outer sleeve.

21. A system for sealing a jumper cable and connector assembly, the system comprising:
an interface cover comprising:
a lid, and
a sleeve extending from the lid, the sleeve adapted to receive the interface end of a cable connector, the sleeve having an outer surface, and a unitary elongated body comprising:
a cable end,
an interface end opposite the cable end,
a passageway extending from the cable end to the interface end, the cable end of the passageway adapted to elastically engage a cable, and
a sealing region on an interior surface at the interface end of the passageway, the sealing region configured to sealingly receive the sleeve of the interface cover,
wherein an environmental seal exists between the outer surface of the sleeve and the sealing region of the weatherproof cover.

22. The system of claim 21, wherein the unitary elongated body is reusable.

23. The system of claim 21, wherein the outer surface of the sleeve is etched.

24. The system of claim 21, wherein the sealing region of the passageway is serrated.

25. The system of claim 21, wherein the unitary elongated body further comprises:
an elongated first section that terminates in a cable end, and
an elongated second section that terminates in a connector end,
wherein said first section and said second section extend along respective axes that are relatively oriented to one another at an angle other than 180 degrees.

26. The system of claim 21, further including an adaptor in sealing communication with the unitary elongated body, wherein a portion of the adaptor is adapted to be positioned between the interior surface of the passageway and the sleeve of the interface cover, such that the environmental seal further comprises the adaptor.

27. A coaxial cable connector interface cover for use with a weatherproof cover having an inner surface, the coaxial cable connector interface cover comprising:
a lid, and
an outer sleeve extending from the lid, the outer sleeve configured to establish an environmental seal at the inner surface of the weatherproof cover.

28. A method of establishing an environmental seal on a jumper cable and connector assembly, the method comprising:
sliding an interface cover onto a connector, the connector having a cable end, a connector body, and an interface end, the interface cover comprising a lid and a sleeve extending from the lid, the sleeve configured to form an environmental seal at an inner surface of a weatherproof cover, and
sliding the weatherproof cover over the connector and the sleeve, the weatherproof cover comprising a cavity configured to surround the cable end and the connector body of the connector, the cavity being open at the interface end of the connector,
wherein an environmental seal is formed around the connector.

29. The method of claim 28, further comprising an intermediate step of:
advancing the weatherproof cover over a coaxial cable toward the connector installed at an end of the coaxial cable.

30. A system for sealing the terminal end of a cable comprising:
a removable cap comprising:
a lid, and
a sleeve extending from the lid, the sleeve having an outer surface, and
a cable cover comprising:
a cable end adapted to elastically engage a cable,
a cap end opposite the cable end, and
a sealing region configured to overlappingly receive the sleeve of the removable cap,
wherein an environmental seal is formed between the outer surface of the sleeve and the overlapping sealing region of the cable cover.
